(19) United States
(12) Patent Application Publication
(10) Pub. No.: US 2026/0320888 A1
(43) Pub. Date: Oct. 15, 2026

(54) SYSTEM AND METHOD OF PRESENTING IMMERSIVE VISUALIZATION ASSOCIATED WITH AUDIO TRACKS

(71) Applicant: Apple Inc., Cupertino, CA (US)

(72) Inventors: Danvin RUANGCHAN, San Jose, CA (US); Alexander B. GROSSMAN, San Francisco, CA (US); Brian S. MCGEE, Los Angeles, CA (US); Carla Y. BLAIR, Pasadena, CA (US); Michael ZARCONE, Los Angeles, CA (US); Scott W. WILSON, San Jose, CA (US); Sruti HARIKUMAR, Los Gatos, CA (US)

(21) Appl. No.: 19/549,866

(22) Filed: Feb. 25, 2026

Related U.S. Application Data
(60) Provisional application No. 63/765,367, filed on Feb. 28, 2025.
(60) Provisional application No. 63/925,288, filed on Nov. 25, 2025.
(60) Provisional application No. 63/970,961, filed on Jan. 29, 2026.

(51) Int. Cl. G06T 13/20; G06F 3/01; G06F 3/16; G06T 15/10; H04S 7/00

(52) U.S. Cl. CPC G06T 13/205; G06F 3/011; G06F 3/165; G06T 15/10; H04S 7/308; H04S 2400/11

(57) ABSTRACT

Computer-generated visualization accompanies playback of an audio track. In some examples, systems and methods include detecting, via the one or more input devices, a first input corresponding to a request to playback a first audio track in an immersive mode at the electronic device. In response to detecting the first input the method may further include retrieving a set of audio data from a respective application associated with the first audio track. The method may further include generating, using the set of audio data, a plurality of time synchronized metadata. The method may further include presenting, via the one or more displays, a computer-generated visualization using the plurality of time synchronized metadata in a three-dimensional environment, where the computer-generated visualization includes a three-dimensional visualization corresponding to the first audio track in accordance with the immersive mode of playback.

### CROSS REFERENCE TO RELATED APPLICATIONS

This application claims the benefit of U.S. Provisional Application No. 63/970,961, filed Jan. 29, 2026, U.S. Provisional Application No. 63/925,288, filed Nov. 25, 2025, and U.S. Provisional Application No. 63/765,367, filed Feb. 28, 2025, the contents of which are herein incorporated by reference in their entireties for all purposes.

### FIELD OF THE DISCLOSURE

This relates generally to systems and methods of presenting immersive visualization associated with audio tracks in three-dimensional environments.

### BACKGROUND OF THE DISCLOSURE

Some computer graphical environments provide two-dimensional and/or three-dimensional environments where at least some visual elements are displayed for a user's viewing are virtual and generated by a computer corresponding to an audio playback. In some examples, the visual elements are presented in response to perceptual aspects of an audio track such as an accented audio note, a beat per minute change, an increase or decrease in volume or the like. However, these approaches are limited to being reactive to the audio track (e.g., visual elements are generated with a delay after detecting perceptual aspects during playback), which results in a degraded user experience.

### SUMMARY OF THE DISCLOSURE

Some examples of the disclosure are directed to systems and methods for presenting immersive visualization associated with audio tracks that use time synchronized metadata to generate a computer-generated visualization. By incorporating the time synchronized metadata into a recipe, the systems and methods described herein provide a proactive, rather than a reactive, approach to immersive playback of audio tracks, thereby improving the visual feedback provided to the user and producing a visualization that improves audio and visual synchronization.

In one general aspect, the method may include, at an electronic device in communication with one or more displays and one or more input devices: detecting, via the one or more input devices, a first input corresponding to a request to playback a first audio track in an immersive mode at the electronic device; and in response to detecting the first input: retrieving a set of audio data from a respective application associated with the first audio track; generating, using the set of audio data, a plurality of time synchronized metadata; and presenting, via the one or more displays, a computer-generated visualization using the plurality of time synchronized metadata in a three-dimensional environment, where the computer-generated visualization includes a three-dimensional visualization corresponding to the first audio track in accordance with the immersive mode of playback. Other examples of this aspect include corresponding computer systems, apparatus, and computer programs stored on one or more computer storage devices, each configured to perform the actions of the methods.

In one general aspect, the electronic device may include one or more processors and one or more programs stored in the memory and configured to be executed by the one or more processors. The one or more programs include instructions for: detecting, via one or more input devices, a first input corresponding to a request to playback a first audio track in an immersive mode at the electronic device; and in response to detecting the first input: retrieving a set of audio data from a respective application associated with the first audio track; generating, using the set of audio data, a plurality of time synchronized metadata; and presenting, via one or more displays, a computer-generated visualization using the plurality of time synchronized metadata in a three-dimensional environment. The computer-generated visualization includes a three-dimensional visualization corresponding to the first audio track in accordance with the immersive mode of playback. Other examples of this aspect include corresponding computer systems, apparatus, and computer programs stored on one or more computer storage devices, each configured to perform the actions of the methods.

In another general aspect, a non-transitory computer readable storage medium storing one or more programs may include one or more instructions for detecting, via one or more input devices, a first input corresponding to a request to playback a first audio track in an immersive mode at the electronic device. The non-transitory computer readable storage medium storing one or more programs may also include instructions for, in response to detecting the first input: retrieving a set of audio data from a respective application associated with the first audio track; generating, using the set of audio data, a plurality of time synchronized metadata; and presenting, via one or more displays, a computer-generated visualization using the plurality of time synchronized metadata in a three-dimensional environment. The computer-generated visualization includes a three-dimensional visualization corresponding to the first audio track in accordance with the immersive mode of playback. Other examples of this aspect include corresponding computer systems, apparatus, and computer programs stored on one or more computer storage devices, each configured to perform the actions of the methods.

Some examples of the disclosure are directed to systems and methods of displaying a two-dimensional computer-generated visualization on a display of an electronic device while outputting an audio track. In some examples, a method is performed at an electronic device in communication with one or more displays and one or more input devices. In some examples, the electronic device detects, via the one or more input devices, a first input corresponding to a request to playback a first audio track at the electronic device. In some examples, in response to detecting the first input, the electronic device retrieves a set of audio data from a respective application associated with the first audio track, generates, using the set of audio data, a recipe that includes a first plurality of time synchronized metadata, and displays, via the one or more displays, a first visualization using the recipe, wherein the first visualization corresponds to the playback of the first audio track. In some examples, while displaying the first visualization, the electronic device detects, via the one or more input devices, a second input corresponding to interaction with the first visualization. In some examples, in response to detecting the second input, the electronic device generates, using the set of audio data and input data corresponding to the second input, an updated recipe that includes a second plurality, different from the first plurality, of time synchronized metadata, and displays, via the one or more displays, a second visualization using the updated recipe, wherein the second visualization corresponds to the playback of the first audio track.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting a three-dimensional environment according to some examples of the disclosure.

FIGS. 2A-2B illustrate block diagrams of example architectures for electronic devices according to some examples of the disclosure.

FIGS. 3A-3D illustrate an example of presenting a computer-generated visualization in an immersive mode of the electronic device according to some examples of the disclosure.

FIGS. 4A-4B illustrate block diagrams of example architectures for generating the computer-generated visualization according to some examples of the disclosure.

FIG. 5 illustrates an example of a computer-generated visualization rendering process according to some examples of the disclosure.

FIG. 6 illustrates examples of time-synchronized metadata according to some examples of the disclosure.

FIG. 7 illustrates an example of presenting a real time editing interface for the computer-generated visualization in an immersive mode of the electronic device according to some examples of the disclosure.

FIG. 8 illustrates a flow diagram illustrating an example process for displaying an extended reality environment for presenting the computer-generated visualization in an immersive mode of the electronic device according to some examples of the disclosure.

FIGS. 9A-9H illustrate examples of displaying a two-dimensional computer-generated visualization on a display of an electronic device while outputting an audio track according to some examples of the disclosure.

FIG. 10 illustrates a flow diagram illustrating an example process for displaying a two-dimensional computer-generated visualization on a display of an electronic device while outputting an audio track according to some examples of the disclosure.

### DETAILED DESCRIPTION

Some examples of the disclosure are directed to systems and methods for presenting immersive visualization associated with audio tracks that use time synchronized metadata to generate a computer-generated visualization. By incorporating the time synchronized metadata into a recipe, the systems and methods described herein provide a proactive, rather than a reactive, approach to immersive playback of audio tracks, thereby improving the visual feedback provided to the user and producing a visualization that improves audio and visual synchronization.

In one general aspect, the method may include, at an electronic device in communication with one or more displays and one or more input devices: detecting, via the one or more input devices, a first input corresponding to a request to playback a first audio track in an immersive mode at the electronic device; and in response to detecting the first input: retrieving a set of audio data from a respective application associated with the first audio track; generating, using the set of audio data, a plurality of time synchronized metadata; and presenting, via the one or more displays, a computer-generated visualization using the plurality of time synchronized metadata in a three-dimensional environment, where the computer-generated visualization includes a three-dimensional visualization corresponding to the first audio track in accordance with the immersive mode of playback. Other examples of this aspect include corresponding computer systems, apparatus, and computer programs recorded on one or more computer storage devices, each configured to perform the actions of the methods.

In one general aspect, electronic device may include one or more processors; one or more programs, where the one or more programs are stored in the memory and configured to be executed by the one or more processors, the one or more programs including instructions for: detecting, via one or more input devices, a first input corresponding to a request to playback a first audio track in an immersive mode at the electronic device; and in response to detecting the first input: retrieving a set of audio data from a respective application associated with the first audio track; generating, using the set of audio data, a plurality of time synchronized metadata; and presenting, via one or more displays, a computer-generated visualization using the plurality of time synchronized metadata in a three-dimensional environment, where the computer-generated visualization includes a three-dimensional visualization corresponding to the first audio track in accordance with the immersive mode of playback. Other examples of this aspect include corresponding computer systems, apparatus, and computer programs recorded on one or more computer storage devices, each configured to perform the actions of the methods. In another general aspect, non-transitory computer readable storage medium storing one or more programs may include detecting, via one or more input devices, a first input corresponding to a request to playback a first audio track in an immersive mode at the electronic device. Non-transitory computer readable storage medium storing one or more programs may also include in response to detecting the first input: retrieving a set of audio data from a respective application associated with the first audio track; generating, using the set of audio data, a plurality of time synchronized metadata; and presenting, via one or more displays, a computer-generated visualization using the plurality of time synchronized metadata in a three-dimensional environment, where the computer-generated visualization includes a three-dimensional visualization corresponding to the first audio track in accordance with the immersive mode of playback. Other examples of this aspect include corresponding computer systems, apparatus, and computer programs recorded on one or more computer storage devices, each configured to perform the actions of the methods.

Some examples of the disclosure are directed to systems and methods of displaying a two-dimensional computer-generated visualization on a display of an electronic device while outputting an audio track. In some examples, a method is performed at an electronic device in communication with one or more displays and one or more input devices. In some examples, the electronic device detects, via the one or more input devices, a first input corresponding to a request to playback a first audio track at the electronic device. In some examples, in response to detecting the first input, the electronic device retrieves a set of audio data from a respective application associated with the first audio track, generates, using the set of audio data, a recipe that includes a first plurality of time synchronized metadata, and displays, via the one or more displays, a first visualization using the recipe, wherein the first visualization corresponds to the playback of the first audio track. In some examples, while displaying the first visualization, the electronic device detects, via the one or more input devices, a second input corresponding to interaction with the first visualization. In some examples, in response to detecting the second input, the electronic device generates, using the set of audio data and input data corresponding to the second input, an updated recipe that includes a second plurality, different from the first plurality, of time synchronized metadata, and displays, via the one or more displays, a second visualization using the updated recipe, wherein the second visualization corresponds to the playback of the first audio track.

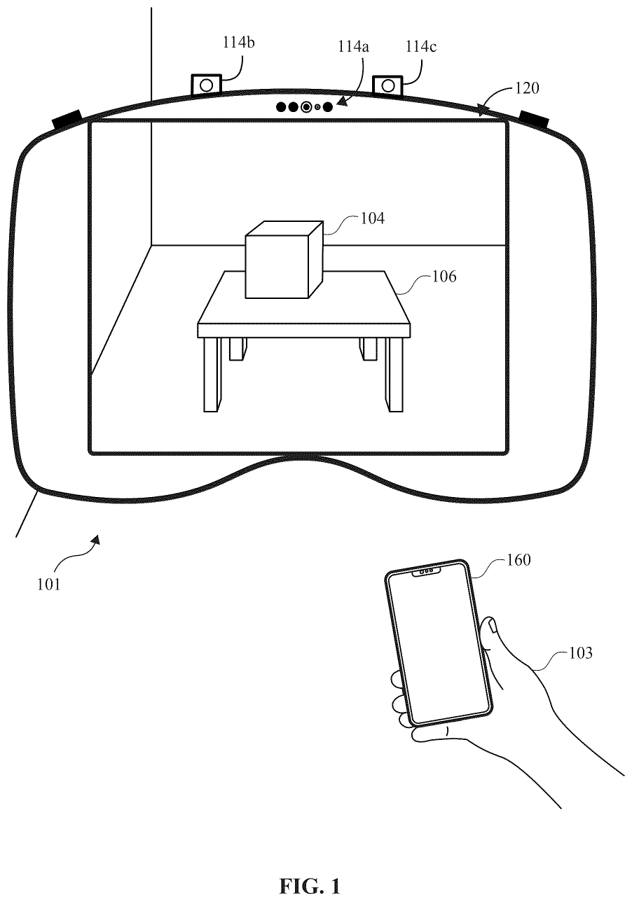

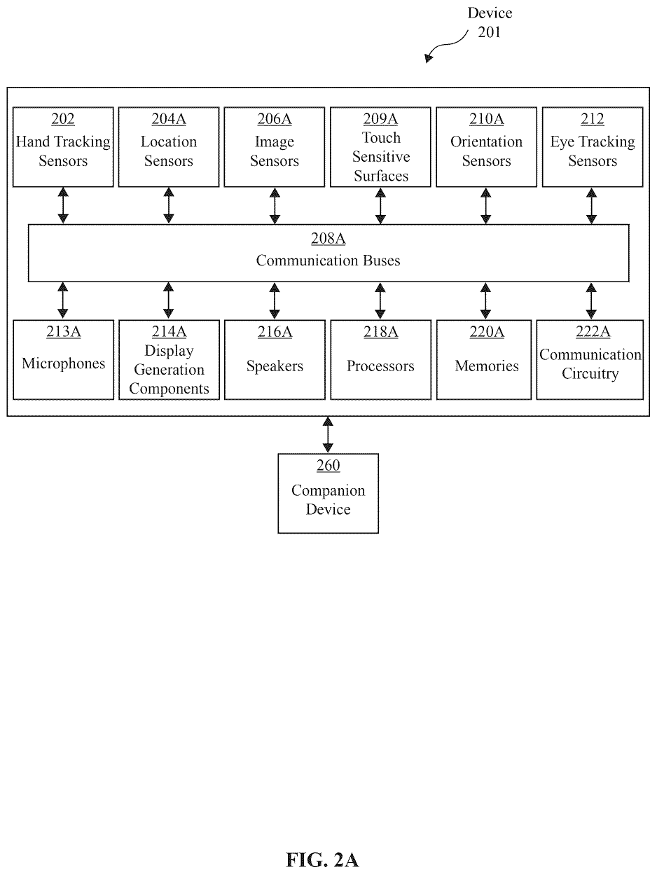

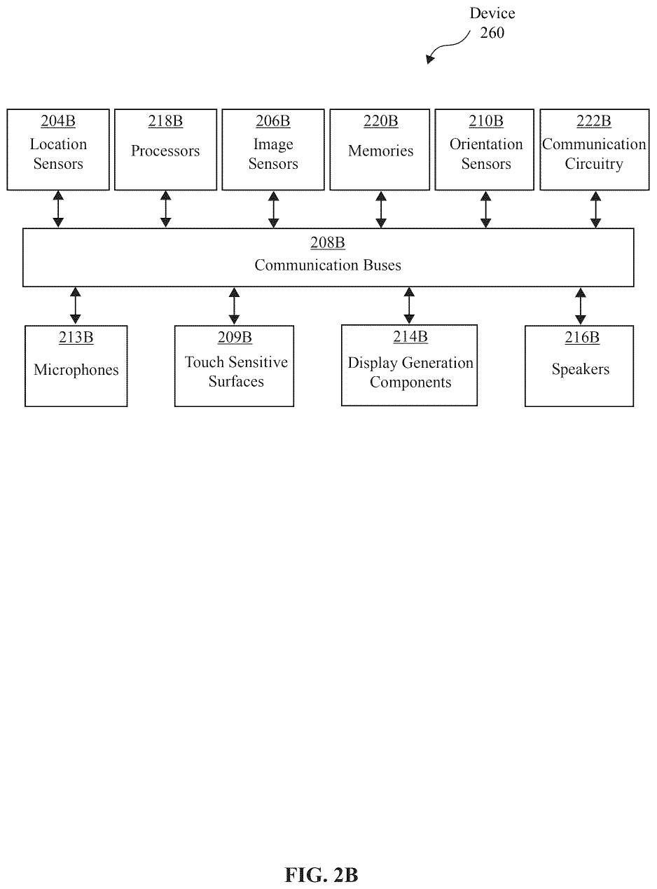

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c). For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 can be displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the description that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards improving user experience for consumption of media in an immersive three-dimensional environment that is synchronized with an audio track and with one or more virtual objects that are displayed in a three-dimensional environment presented at an electronic device (e.g., corresponding to electronic device 201).

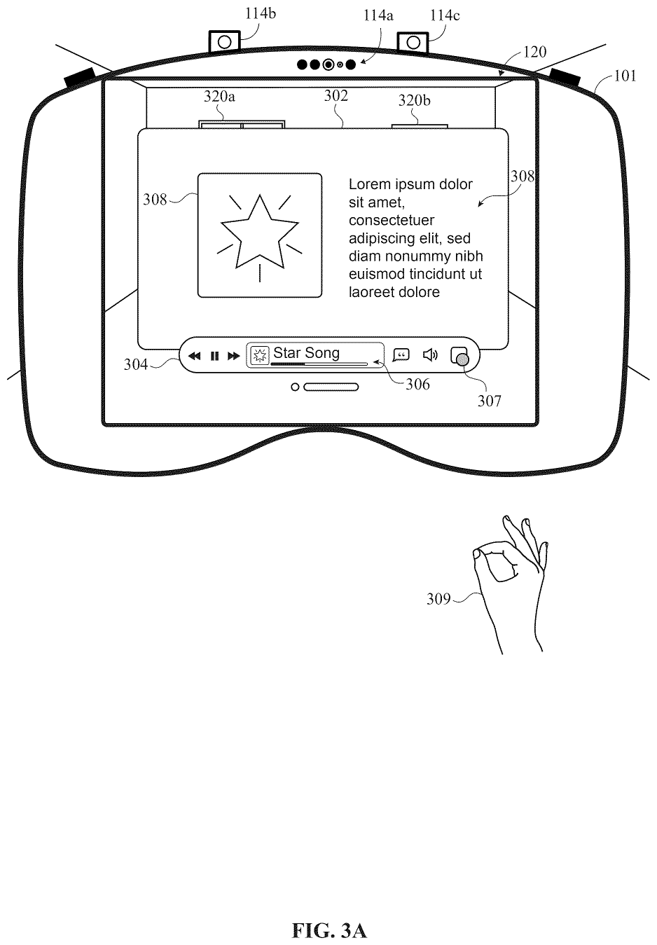

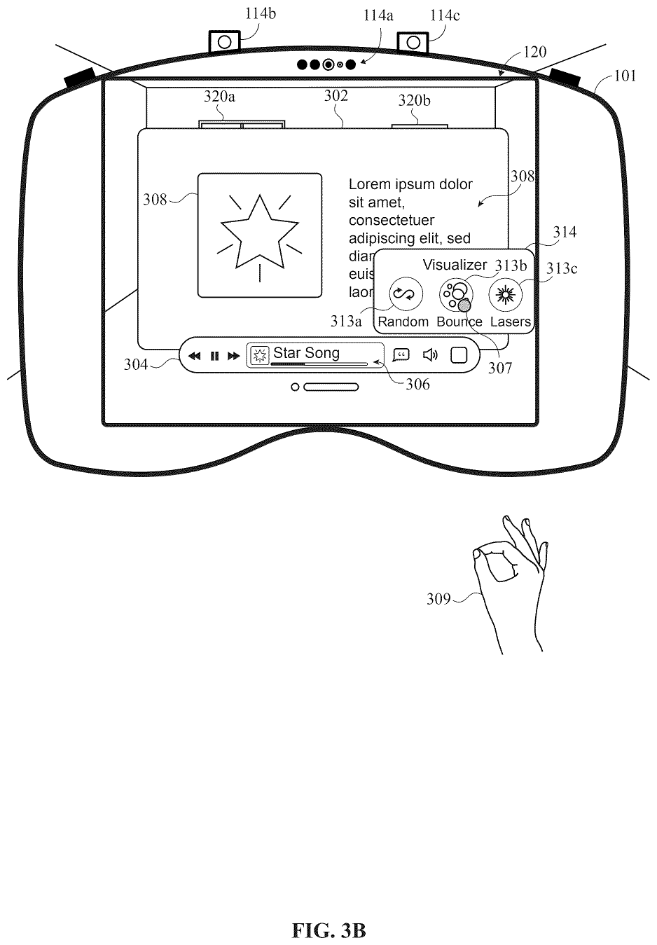

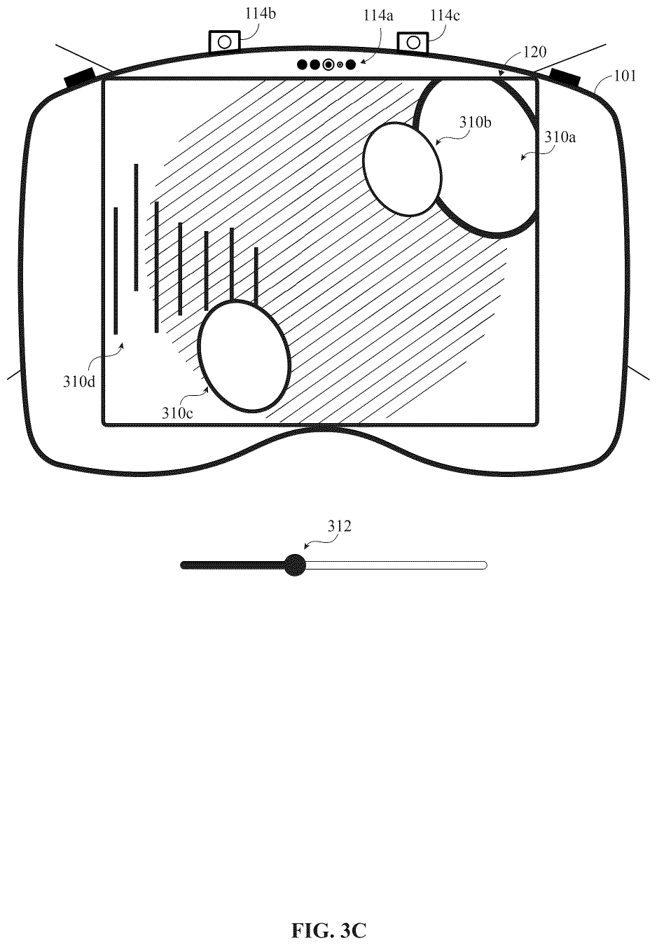

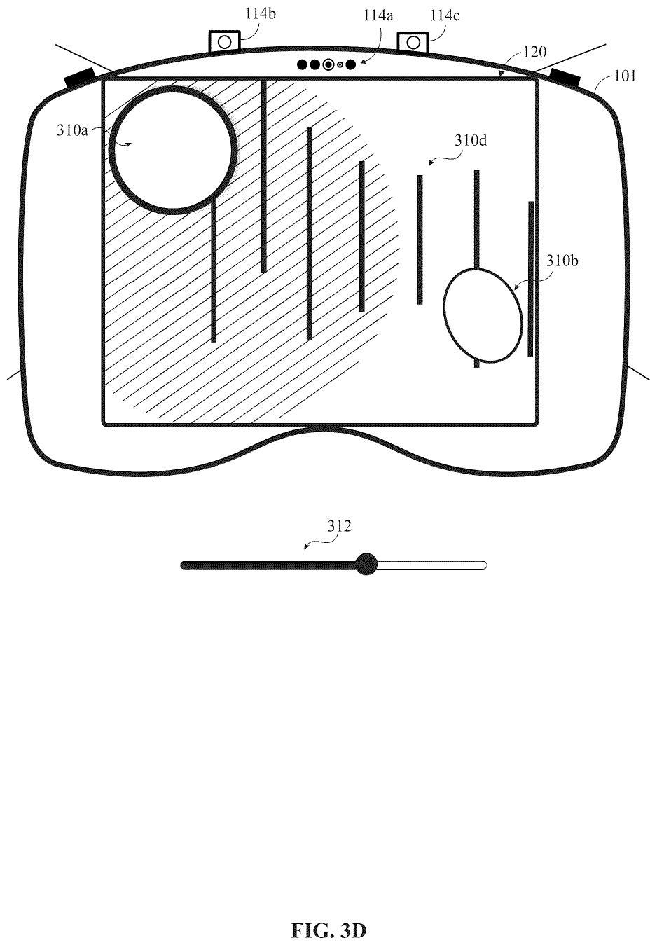

FIGS. 3A-3D illustrate an example of presenting a computer-generated visualization in an immersive mode of the electronic device according to some examples of the disclosure. In some examples, the electronic device 101 may present a three-dimensional environment via display 120. As described above, the electronic device 101 may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. The three-dimensional environment presented via the display 120 may be defined by X, Y and Z axes (or defined by other coordinates) as viewed from a perspective of the electronic device (e.g., a viewpoint associated with the electronic device 101, which may be a head-mounted display, for example).

As shown in FIG. 3A, the electronic device 101 may be in a physical environment that includes a first window 320A and a second window 320B. Thus, the three-dimensional environment 330 presented using the electronic device 101 optionally includes captured portions of the physical environment surrounding the electronic device 101, such as a representation of the first window 320A and the representation of the second window 320B. Additionally, the three-dimensional environment 330 may include representations of the floor, ceiling, and walls of the room in which the electronic device 101 is located.

As shown in FIG. 3A, the electronic device 101 may present a music selection interface 302 via display 120. The music selection interface 302 may include multiple selectable options including playback controls 304, an audio track identifier 306, additional audio track data 308 (e.g., lyrics, album cover art, artist name, artist logo, etc.), and audio/video controls 304. The electronic device 101 may present the music selection interface 302 in an immersive mode using an extended reality environment. In some examples, the electronic device 101 may be in communication with one or more displays and one or more input devices. As described above, the input devices may be configured to detect a first input, such as movement of one or more hands and/or one or more air gestures of a user of the electronic device. The detection of the first input may correspond to a request to playback a first audio track (e.g., Star Song) in an immersive mode at the electronic device. For example, the first input may correspond to a request to activate one of the playback controls 304, such as via an air pinch gesture performed by a hand 309 of the user corresponding to selection of a playback control (e.g., while gaze 307 of the user is directed to the playback control).

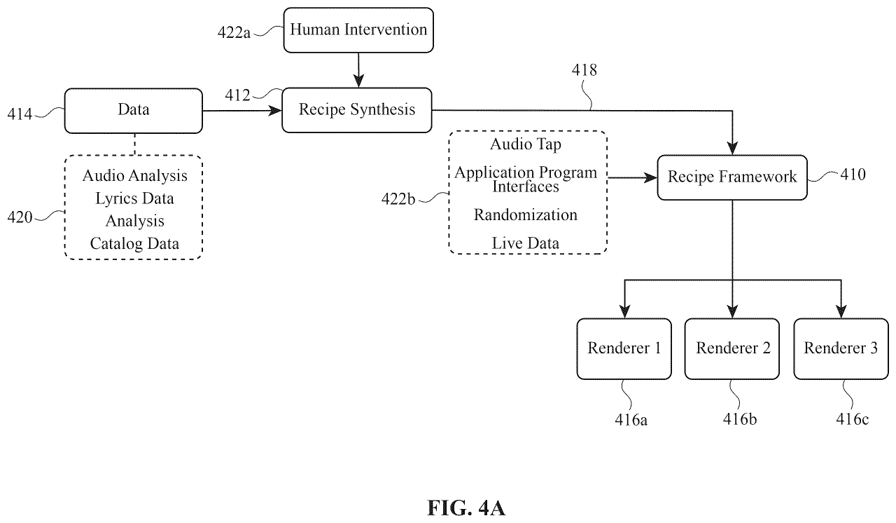

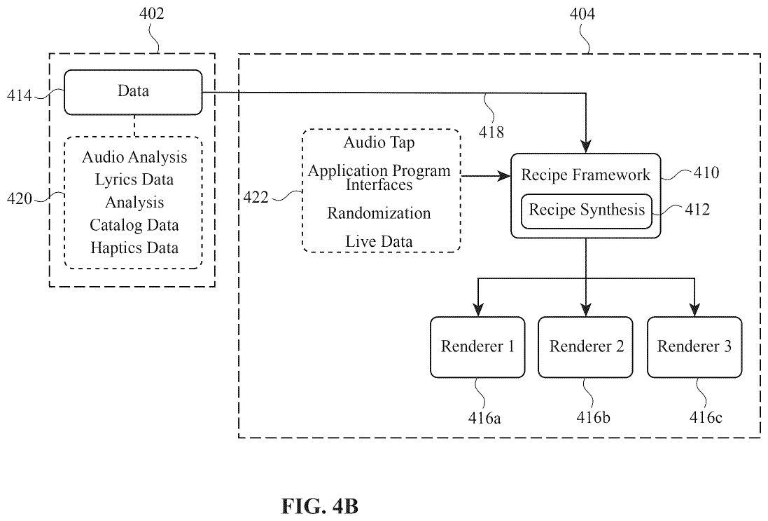

In some examples, as shown in FIG. 3B, in response to detecting the first input discussed above, the electronic device 101 displays, via display 120, menu 314 that is associated with the immersive mode discussed above. For example, as shown in FIG. 3B, the electronic device 101 displays the menu 314 concurrently with the music selection interface 302 in the three-dimensional environment, where the menu 314 enables the user of the electronic device 101 to select/designate a particular theme (e.g., form or type) for a computer-generated visualization that is to be displayed in the three-dimensional environment within the immersive mode of playback. In some examples, as shown in FIG. 3B, the menu 314 includes a plurality of selectable options 313 corresponding to a plurality of themes for the computer-generated visualization. For example, in FIG. 3B, the menu 314 includes a first selectable option 313a corresponding to a first theme (e.g., Random), a second selectable option 313b corresponding to a second theme (e.g., Bounce), and a third selectable option 313c corresponding to a third theme (e.g., Lasers). In some examples, the plurality of selectable options corresponding to the plurality of themes is scrollable within the menu 314 to reveal additional and/or alternative themes (e.g., that are not currently displayed or visible within the menu 314). For example, the electronic device 101 is configured to scroll (e.g., in response to user input, such as an air pinch and drag gesture directed to a portion of the menu 314) the plurality of selectable options 313 horizontally (e.g., leftward from the viewpoint) within the menu 314 to reveal a fourth, a fifth, a sixth, etc. selectable option corresponding to a respective theme for the computer-generated visualization. Selecting a particular theme for the computer-generated visualization is described in more detail below with reference to FIGS. 4A-4B.

In FIG. 3B, while displaying the menu 314, the electronic device 101 detects a second input provided by the user of the electronic device 101 corresponding to a selection of the second representation 313b corresponding to the second theme in the three-dimensional environment. For example, as shown in FIG. 3B, the electronic device 101 detects an air pinch gesture performed by the hand 309 of the user, optionally while the gaze 307 of the user is directed to the second representation 313b in the menu 314. In some examples, as described in more detail below, in response to detecting the selection of the second representation 313b, the electronic device 101 initiates a process to display a computer-generated visualization corresponding to the first audio track (e.g., Star Song) in accordance with the immersive mode of playback. Additionally, in some examples, in response to detecting the selection of the second representation 313b, the electronic device 101 ceases display of the menu 314 in the three-dimensional environment.

Upon detecting the first input and/or the second input above, the electronic device 101 may retrieve a set of audio data from a respective application associated with the first audio track. The set of audio data may be retrieved from a local memory, a cloud repository, a media server, or any data storage environment. The electronic device 101 uses the set of audio data to generate a recipe that includes a plurality of time synchronized metadata. The recipe may include a set of instructions based on a set of display parameters that causes the computer-generated visualization to be a three-dimensional spatial visualization. Additional details of the recipe are discussed with reference to FIGS. 4-7 and/or 9A-9H. The electronic device 101 may present, via the one or more displays, a computer-generated visualization using the recipe in a three-dimensional environment such as by presenting the computer-generated visualization that includes a three-dimensional visualization corresponding to the first audio track in accordance with the immersive mode of playback.

FIG. 3C illustrates the electronic device presenting, via the display, a computer-generated visualization. In some examples, the electronic device 101 presents, via the display 120, the three-dimensional visualization corresponding to the first audio track in accordance with the immersive mode of playback (e.g., and having a (e.g., initial) visual appearance, such as a shape, form, coloration, immersion, or dimensionality, defined according to the selected theme in FIG. 3B (e.g., Bounce)). As used herein, the immersive mode of playback optionally refers to virtual content that is presented on the entire display 120 of the electronic device 101, without passthrough of the physical environment presented on the display 120. Alternatively, in some examples, the immersive mode of playback refers to virtual content that is presented as three-dimensional virtual content that is overlaid on the passthrough of the physical environment presented on the display 120 (e.g., such as within an extended reality environment). In some examples, the virtual content is customizable using a control of the electronic device (e.g., a button, a menu interface, or the like) to adjust an amount of passthrough of the physical environment that is presented within and/or visible within the three-dimensional environment. In some examples, when the electronic device 101 enters the immersive mode of playback, the display 120 ceases to present the music selection interface 302. The computer-generated visualization may include visual representations of the set of audio data that are generated by converting metadata corresponding to phases, lyrical data, catalog data, duration data, or acoustic parameters associated with the audio track, among other possibilities. In some examples, the electronic device 101 may further communicate with one or more audio speakers. The electronic device 101 may be configured to perform operations including determining a type of the one or more audio speakers from various types of audio speakers. Each speaker type may have an associated latency parameter which may depend on the hardware (e.g., Bluetooth earphones or headphones, corded earphones or headphones, other wireless speakers, etc.). Using the latency parameter associated with the speaker type, the electronic device 101 may synchronize presentation of audio via the speakers with the computer-generated visualizations. For example, using the latency parameter associated with the speaker type, the electronic device 101 may be configured to generate a compensation parameter that may represent an adjustment to a visual appearance of the computer-generated visualization. The electronic device 101 may be further configured to apply the adjustment to the visual appearance of the computer-generated visualization in accordance with the compensation parameter. For example, for a speaker type with a large latency parameter (e.g., more than a threshold time (e.g., in milliseconds, microseconds, nanoseconds, etc.) of delay), the adjustment may delay the presentation of the computer-generated visualization such that the presentation of the visual appearance and the audio playback are synchronized. In some examples, various speaker types have different latency parameters. For example, a first latency parameter applies to a first speaker device (e.g., a wired speaker), while a second, different latency parameter (shorter or longer) applies to a second speaker device (e.g., a Bluetooth or wireless speaker). In some such examples, the electronic device (e.g., automatically) selects the latency parameter that corresponds to the speaker type or the specific speaker device that is communicatively coupled to the electronic device (optionally without user input). As the electronic device 101 is presenting objects (e.g., objects 310a-310d) associated with the computer-generated visualization via the display, one or more objects (optionally each object) that are displayed may have a unique visual characteristic (e.g., a shape, a position, and/or an orientation) that defines the object within the three-dimensional environment (e.g., and selected according to the theme above (e.g., Bounce)). For example, a first object may be a particle type of object (e.g., a first type of object) or a curvilinear feature object (e.g., a second type of object), among of possible object types. In some examples, as mentioned above, the objects 310a-310d can be presented on the display 120 in a fully immersive (e.g., virtual) environment or in an extended reality (e.g., overlaid on the passthrough the physical environment). As shown in FIGS. 3C-3D, the display 120 is illustrated presenting multiple types of objects that may be independently generated to correspond to an audio feature of the audio track (e.g., a respective object generated to correspond to a respective audio feature). As discussed below, some of the objects correspond to accent portions of the audio track while other objects correspond to a verse, chorus, sentiment, or other aspects of the audio track.

FIG. 3D illustrates the electronic device presenting, via the display, a computer-generated visualization at another point in time that may be subsequent to the computer-generated visualization illustrated by FIG. 3C. For example, FIG. 3D illustrates a time position indicator 312 that represents a time stamp of the audio track (e.g., 2 minutes and 3 seconds in a 4-minute audio track). The time position indicator 312 may visually move along a line or bar that represents the audio track such that the time position indicator 312 moves from a starting end of the line towards a finishing end of the line corresponding to the progression of audio playback of the audio track. It should be understood that, in some examples, the time position indicator 312 is not a visual element that is displayed in the three-dimensional environment at the electronic device 101. Additionally or alternatively, it should be understood that as used herein, the passage of time can be represented differently.

In some examples, the user of the electronic device 101 may provide an initial set of conditions (e.g., a first or default) including a position, field of view, altitude, and other parameters within the three-dimensional environment. For example, when the user of the electronic device 101 initially selects an audio track (e.g., Star Song in FIG. 3A) and initializes presentation of the computer-generated visualization at the electronic device 101 (e.g., in FIG. 3B), the electronic device 101 automatically associates the initial set of conditions with the computer-generated visualization, where the initial set of conditions is provided via user input prior to the selection of the audio track. In some examples, while the electronic device 101 initiates the presentation of the computer-generated visualization, the display 120 starts presenting objects in the three-dimensional environment within the initial field of view of the electronic device 101. The electronic device 101, using the recipe framework or rendering process described below, assigns distances between the position of the electronic device 101 and the objects and visual attributes in the three-dimensional environment. As described herein, if the location of the user of the electronic device 101 moves or changes, such that a position and/or an orientation of the electronic device 101 is updated in the physical environment, the field of view (and portion of the computer-generated visualization corresponding to the field of view) moves in the three-dimensional environment in accordance with the movement, which causes an updated portion of the computer-generated visualization to be displayed/visible. Additionally or alternatively, if the user of the electronic device 101 performs an interaction on an object displayed in the three-dimensional environment (e.g., moving a hand of the user to push the object), the electronic device 101 alters display of the object in the three-dimensional environment in accordance with the interaction (e.g., moves the object in the three-dimensional environment). As will be understood, the computer-generated visualization illustrated in FIG. 3D is different than the computer-generated visualization illustrated in FIG. 3C due to progression of the playback through a different time position in the audio track. As the playback progresses, the recipe described below may have different values that are used for generating the computer-generated visualization, which causes one or more aspects (e.g., including a visual appearance) of the computer-generated visualization to change.

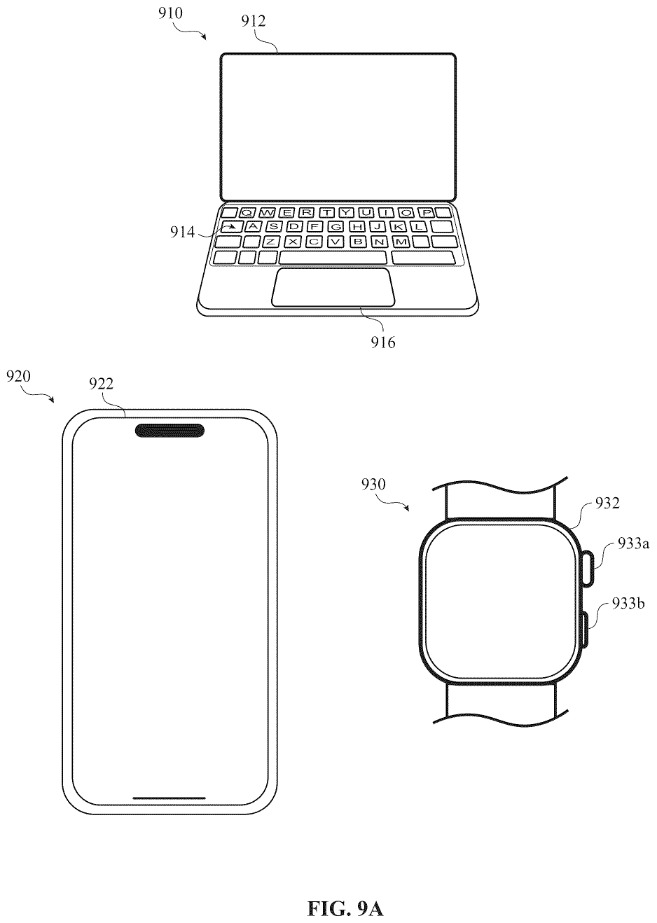

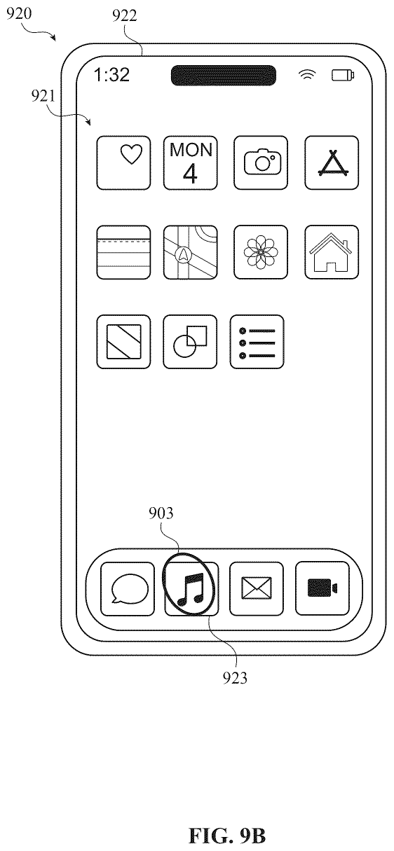

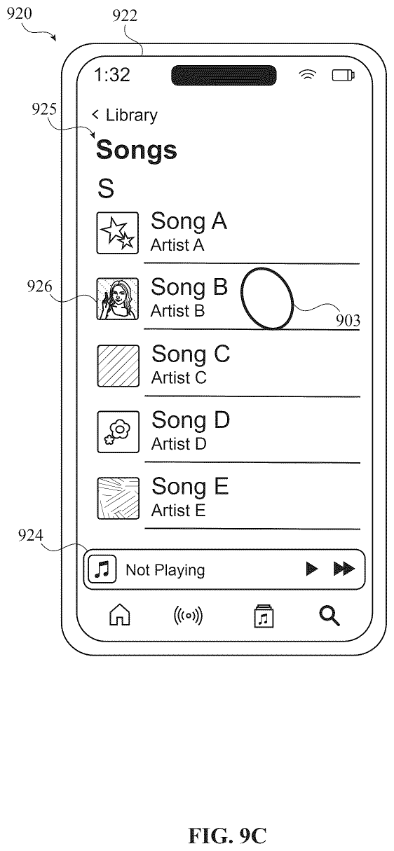

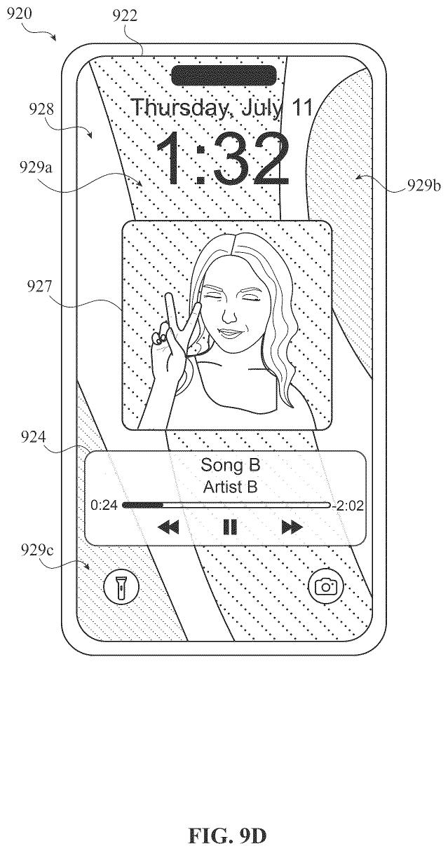

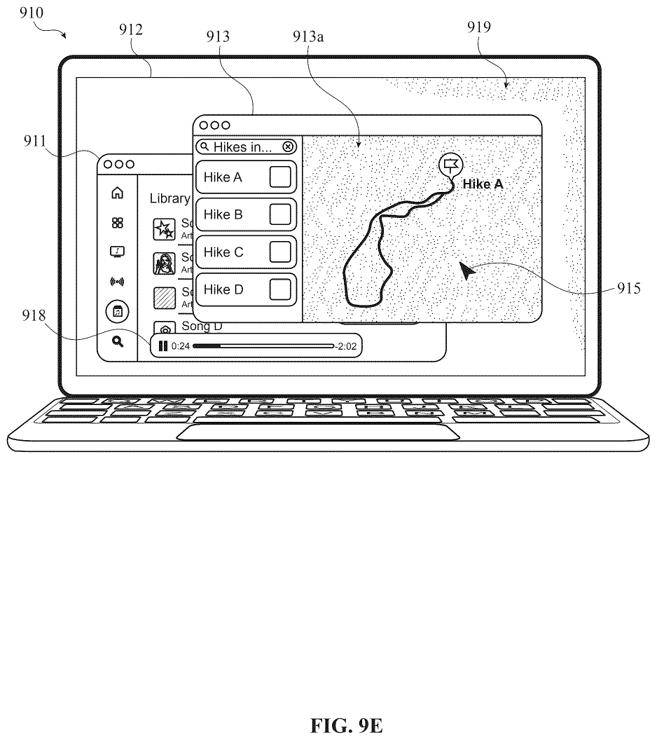

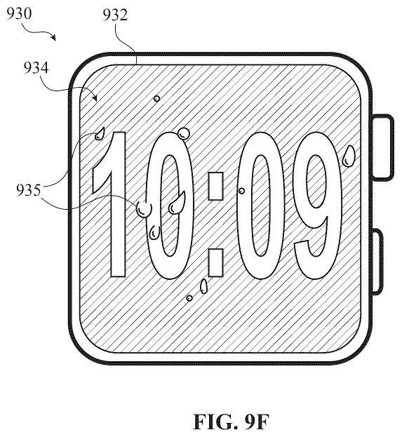

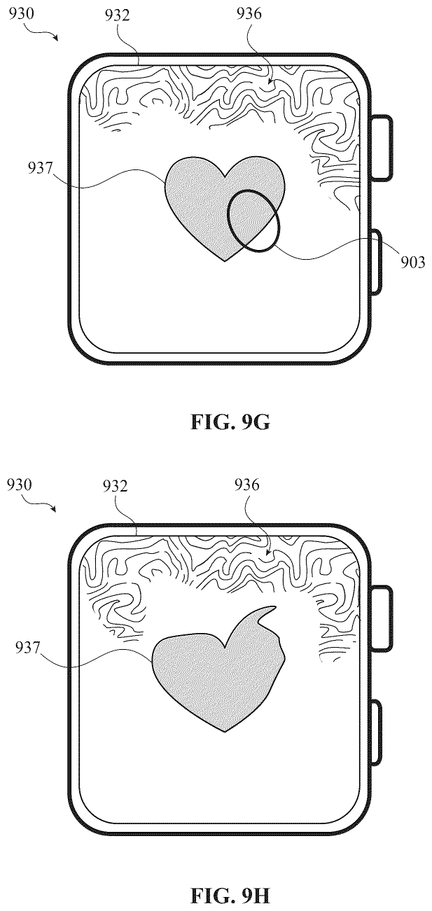

FIGS. 4A-4B illustrate block diagrams of example architectures for generating the computer-generated visualization according to some examples of the disclosure. In some examples, as shown in FIG. 4A, the recipe framework 410 may be configured to operate on an electronic device (e.g., electronic device 101 in FIG. 1, electronic device 201 in FIG. 2A, and/or electronic device 260 in FIG. 2B). In some examples, the recipe framework 410 may be configured to operate at a server (e.g., a wireless communications terminal) in communication with the electronic device. In some examples, as discussed below, the recipe framework 410 may facilitate a computer-generated visualization displayed by the electronic device 101 that includes a plurality of visual elements (e.g., particles, objects, shading, etc.) such as described above with reference to FIGS. 3A-3D and/or FIGS. 9A-9H.

In some examples, as shown in FIG. 4A, the recipe framework 410 is configured to communicate with a recipe synthesis application 412, data source 414, and/or rendering applications 416A-416C. In some examples, as discussed in more detail below, the recipe framework 410 and the recipe synthesis application 412, data source 414, and/or rendering applications 416A-416C transmit and exchange data and other high-level information via one or more Application Program Interfaces (APIs). An API (or APIs), as used herein, can define one or more parameters that are passed between a calling application and other software code (e.g., an operating system, library routine, function) that provides a service, which provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some examples, an API call can report to an application the capabilities of a device running the application, such as input capability, output capability, processing capability, power capability, communications capability, etc.

In some examples, as shown in FIGS. 4A-4B, recipe framework 410 is configured to receive a recipe 418 from the recipe synthesis application 412. For example, as discussed previously with reference to FIGS. 3A-3D, time synchronized metadata (e.g., accent parameters, events, phase parameters, etc.) may be used to generate a computer-generated visualization for display in the three-dimensional environment. As used herein, a recipe may be a set of variables that includes the names and values of each variable. The recipe may be stored in a JavaScript Object Notation (JSON) or other storage schema such as comma-separated values, text file, or the like. In some examples, the recipe synthesis application 412 may generate the recipe using time-synchronized metadata 420 stored in data sources 414. Each of the respective parameters in the time-synchronized metadata, such as the audio analytics, lyrics data, catalog data, haptics data (e.g., including intensity and/or sharpness of vocals within the track and/or instrumentals or other production of the track) or analysis may be used by the recipe synthesis application 412 to generate a recipe. In some examples, the recipe 418 includes information corresponding to an appearance (e.g., color, size, shape, etc.) of a virtual object, interactive features of the virtual object (e.g., whether the object can be moved, selected, etc.), positional information of the virtual object (e.g., placement of the virtual object within the three-dimensional environment), etc. In some examples, as discussed in more detail below, the recipe 418 is utilized by the recipe framework 410 to generate and define display parameters for one or more virtual objects, where the display parameters control the display of the one or more virtual objects in the three-dimensional environment. In some examples, as shown in FIG. 4A, the recipe 418 is received by the recipe framework 410 from the recipe synthesis application 412. In some examples, the set of display parameters includes object parameters including an orientation, a velocity, an acceleration, and environment parameters, which indicates a relative position of the computer-generated visualization from a viewpoint of the electronic device in the three-dimensional environment.

The recipe synthesis application 412 may be executed on the electronic device 101 (e.g., as described in more detail below with reference to FIG. 4B) or at a server that is accessible by the electronic device 101. The recipe synthesis application 412 may receive (or otherwise access) the data sources 414 to retrieve a set of time-synchronized metadata 420. In some examples, the recipe synthesis application 412 may determine a display parameter of the recipe such as an initial color using one or more of parameters in the time-synchronized metadata 420. For example, the recipe synthesis application 412 may determine a sentiment of the lyrics (e.g., happy, sad, angry, excited, etc.) and assign a value to an initial color from any color space (e.g., Red/Green/Blue (RGB), Protocol 3 (P3), High Dynamic Range (HDR), etc.). The initial color may be assigned to the recipe 418. The recipe synthesis application 412 may determine a quantity and type of particles using a loudness parameter (e.g., a measure of intensity), the beats per minute, or the phase of the audio track. For example, the number of particles may be increased as the loudness or beats per minute increases. In another example, the type of particles may be changed (e.g., from circular/spherical to cuboid) when the phase of the audio track changes (e.g., from verse to chorus). The recipe synthesis application 412 may optionally apply a weighting factor to each parameter in the time-synchronized metadata 420. For example, an accent may have a loudness relative to other (e.g., adjacent) portions of the audio track. The recipe synthesis application 412 may adjust, using a weighting factor, the intensity of the accent such that the recipe includes values that provide a seamless visual transition between a visualization (e.g., an object, a visual effect, etc.) of the accent such as a new object appearing, a brightness change, an object disappearing or changing in visual appearance, or other visual accents. In an example, the recipe synthesis application 412 may normalize the values of the time-synchronized metadata to values between [0, 1] or relative to each other using another scaling factor (e.g., [0,10], [0,100], [−1, 1], etc.).

In some examples, the recipe synthesis application 412 generates a recipe that includes a time position within the audio track. The recipe synthesis application 412 may use individual audio attributes in the time-synchronized metadata such as quality or state of being danceable, musical valence, a position of an accent, or a set of weights from a machine learning model. During the generation of the recipe, the recipe synthesis application 412 may assign a base hue and/or a set of initial visual conditions to the recipe. In some cases, these initial visual conditions may include three-dimensional visual data such as positions of objects, initial velocities of the objects, shapes of the objects, etc., and define a viewpoint of the display including an initial orientation, elevation, and field of view. In some examples, the recipe synthesis application 412 may determine a color palette including a plurality of hues to be included in the recipe. Aspects of the time-synchronized metadata such as musical semantics (e.g., manner in which non-musical information is conveyed via the musical sound), a type or category of audio track (e.g., a genre such as folk, rap, R&B, classical), or a user requested palette, may be used by the recipe synthesis application 412 during generation of the hues. In other examples, the color palette may be set using a time interval for a portion of the audio track such that more than one color palette can be used for the visualization (e.g., a first color palette for verses, a second (e.g., different) color palette for a chorus/bridge, etc.). In some examples, the color palette determination may be performed by the recipe synthesis application 412 or at the recipe framework 410 using a process similar to as described above.

In some examples, the recipe may include a set of display parameters that includes object parameters including an orientation, a velocity, an acceleration, an environment parameter, and a relative position of the computer-generated visualization from a viewpoint of the electronic device in the three-dimensional environment. During the display of the computer-generated visualization, the electronic device 101 may receive an input from a user such as a gesture of a hand, movement of the user within the physical environment, or other input that requests and adjustment to display. The recipe framework 410 may apply an adjustment such as a change of a position, an orientation, a velocity, an acceleration, and/or a relative position of an object from a first value in the computer-generated visualization to a second value in the computer-generated visualization. In some instances, a magnitude, a velocity, or an intensity of adjusting the computer-generated visualization is based on the user input (e.g., motion of the one or more hands of the user). In some examples, the set of display parameters may include a set of playlist level parameters and a set of audio track parameters. For example, the set of display parameters can include some parameters which have similar values throughout multiple audio tracks (e.g., a particle energy level for a workout playlist) while some parameters (e.g., hue, number of particles, etc.) may vary widely between audio tracks within the playlist. In some examples, the set of display parameters may include a set of album parameters or artist parameters which have similar values across multiple audio tracks of a particular album or performed by a particular music artist.

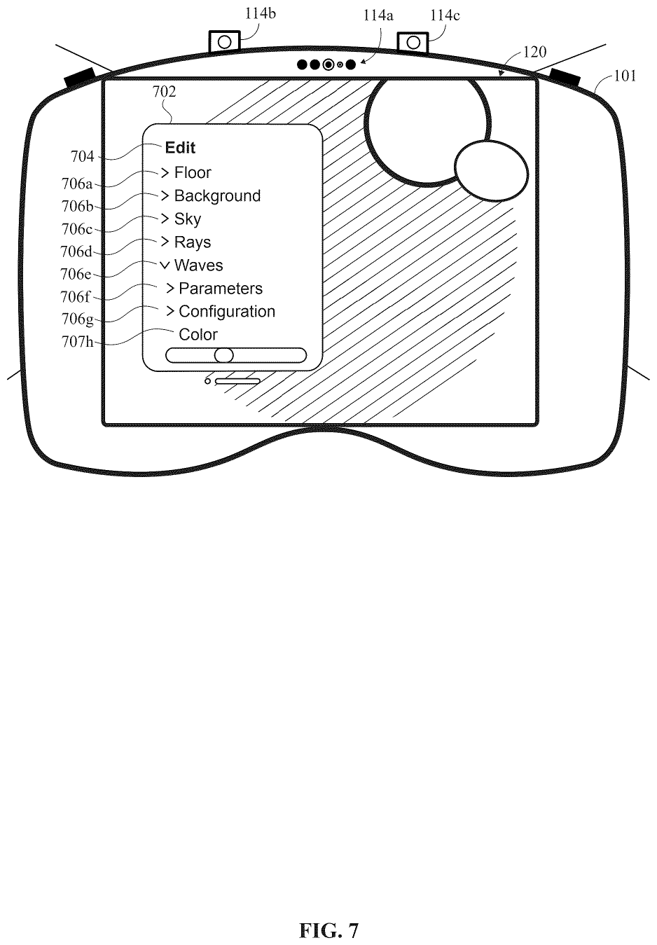

Additionally, the recipe synthesis application 412 may be configured to communicate with a computing device or application such that one or more users of one or more electronic devices may interact with the recipe synthesis application 412. For example, the recipe synthesis application 412 may receive inputs or adjustments from the one or more users (e.g., manual or supervised adjustments to any of the values or variables in the recipe). To receive these inputs, the recipe synthesis application 412 may include a set of APIs such that the one or more users can receive values assigned to the recipe 418 via their respective one or more electronic devices and modify one or more values of the recipe at any time during or after creation of the recipe 418. In some examples, the modifications may be performed using a user interface that may be presented by a display of the respective one or more electronic devices, such as user interface portion 702 of FIG. 7 discussed in more detail below. In some examples, the recipe 418 that is generated may be different for a first computer-generated visualization for an audio track than for a second computer-generated visualization for the same audio track. For example, the process illustrated in FIG. 4A for generating a computer-generated visualization is performed by the electronic device individually for an audio track (e.g., each time the audio track is played at the electronic device) irrespective of whether a respective computer-generated visualization was previously generated for the audio track, resulting in and/or enabling the computer-generated visualization for the audio track to be visually different for the user across different and/or multiple instances of playback. This updated recipe may be optionally generated at the recipe synthesis application 412 or the recipe framework 410.

Additionally, in some examples, the recipe synthesis application 412 is configured to generate values for the recipe 418 that have spatial components. As described above with reference to the three-dimensional environment in which the computer-generated visualization is presented, the recipe synthesis application 412 includes information in the recipe 418 corresponding to a spatial environment (e.g., a three-dimensional environment), such as discussed above with reference to FIGS. 3A-3D, that is generated such that a user of the electronic device 101 can view the computer-generated visualization in an immersive environment where different portions of the computer-generated visualization may be viewed based on a position and/or an orientation of the electronic device.

Additionally or alternatively, in some examples, the recipe synthesis application 412 is configured to generate values for the recipe 418 that include positional information. For example, as discussed in more detail below with reference to FIGS. 9A-9H, the recipe synthesis application 412 includes information in the recipe 418 corresponding to a respective (e.g., two-dimensional) user interface, such as a user interface of a respective application running on the electronic device, that is overlaid with, integrated with, or otherwise displayed with the computer-generated visualization on the (e.g., two-dimensional) display of the electronic device. In some examples, the information in the recipe 418 corresponding to the respective user interface includes a visual appearance of the respective user interface, such as a size, shape, color pattern and/or location of the respective user interface on the display of the electronic device, and/or interactive features of the respective user interface, such as movability of the respective user interface, selectable elements contained in the respective user interface, and/or mode of interaction with the respective user interface (e.g., selection, typing/entering of text, swiping, etc.) on the display of the electronic device. In some examples, as discussed below with reference to FIGS. 9A-9H, the generation of the computer-generated visualization using the recipe 418 enables the user to maintain visibility of and/or interaction with the user interface while the computer-generated visualization is displayed at the electronic device.

Returning to the recipe framework 410, the recipe framework 410 may receive the recipe 418 for display in the three-dimensional environment and/or at the electronic device. The recipe framework 410 may convert the values of the recipe 418 into display parameters for rendering applications 416A-416C, collectively “rendering applications 416.” The rendering applications 416 may render the computer-generated visualization to the display (e.g., such as display 120 of FIG. 1 and/or display generation components 214A/214B of FIGS. 2A-2B) or to another display corresponding to another electronic device (e.g., television (TV), tablet, etc.).

Additionally, during display of the computer-generated visualization, the recipe framework 410 may compute an anticipation progress parameter that represents a current position in the audio track. The recipe framework 410 uses the anticipation progress parameter as a trigger for updating the display with a visual attribute such as a color, a shading, a number of particles, a type of particles, an object appearance, or a visual accent of the computer-generated visualization in the three-dimensional environment, as similarly shown from FIG. 3C to FIG. 3D above and/or in FIGS. 9A-9H below. For example, the anticipation progress parameter may indicate a relative position of a current position in the audio track to a position of a next accent (e.g., an audio event within the audio track).

In some examples, the recipe synthesis application 412 and/or the recipe framework 410 are configured to receive inputs 422A-422B (e.g., from an operating system of the electronic device 101). For example, the inputs 422A-422B may correspond to user input detected via one or more input devices in communication with the electronic device, such as contact-based input detected via a hand gesture-based and/or gaze-based input detected via sensor devices (e.g., hand tracking sensors 114B/114C, and/or eye tracking sensors 114A), and/or other input devices and sensors described previously with reference to FIGS. 2A-2B. In some examples, when the computer-generated visualization is presented via an electronic device that is configured to present three-dimensional content, such as the electronic device 101 in FIG. 1, input 422B includes information corresponding to input that is directed to one or more virtual objects (e.g., contained within and/or included within the computer-generated visualization) that are being displayed in the three-dimensional environment and that are associated with recipe 418 or the recipe framework 410. For example, the input 422B includes information corresponding to input to directly interact with a virtual object, such as moving the virtual object in the three-dimensional environment. In some examples, the input 422B includes information corresponding to input that is directed to the three-dimensional environment that is displayed at the electronic device. For example, the input 422B may include information corresponding to input such as live event data, a randomization component, an audio tap request (e.g., a request to change a tempo of the audio track, simulating audio effects pedals), or a request from one or more APIs (such as from a user interface such as described with reference to the interactions with the recipe synthesis application 412). Additional details relating to the input 422A are described with reference to FIG. 7.

In some examples, the input 422B includes information corresponding to a user designation/selection of a theme for the computer-generated visualization that is to be displayed in the three-dimensional environment. For example, the input 422B includes information corresponding to the input(s) described with reference to FIG. 3B above, such as the selection of the second representation 313b corresponding to the second theme in the menu 314 detected at the electronic device 101. In some examples, a selected theme informs the recipe framework 410 to apply a closed set of variables when converting the values of the recipe 418 into the display parameters for the rendering applications 416A-416C. For example, a respective theme is associated with and/or defines or otherwise drives the visual appearance of the computer-generated visualization (e.g., defining and/or adjusting one or more visual characteristics of the computer-generated visualization during playback of an audio track) within the three-dimensional environment. Returning to FIG. 3B, for example, when the electronic device 101 detects the selection of the second representation 313b corresponding to the second theme (e.g., Bounce), the electronic device 101 provides input data (e.g., input 422B) to the recipe framework 410 indicating that the computer-generated visualization is desired to be presented according to the second theme (e.g., Bounce). Accordingly, the recipe framework 410 applies a closed set of variables to the recipe that is associated with and/or that corresponds to the second theme, which defines the specific virtual objects that are to be rendered and displayed in the three-dimensional environment (e.g., particles and/or orbs), their corresponding visual characteristics (e.g., size, color, shape, hue, brightness, etc.), a number of virtual objects to be displayed in the three-dimensional environment, and/or a movement pattern and/or animation of the virtual objects (e.g., direction of motion, speed of motion, type of motion, etc.), as similarly illustrated in FIGS. 3C-3D.

Additionally or alternatively, in some examples, when the computer-generated visualization is presented via an electronic device that is not configured to present three-dimensional content (e.g., an electronic device having a display limited display that is configured to present two-dimensional environment), such as electronic device 260 in FIGS. 2A-2B, the input 422B includes information corresponding to input that is directed to at least a portion of the computer-generated visualization that is associated with the recipe 418 or the recipe framework 410. For example, the input 422B includes information corresponding to input corresponding to a direct interaction with a portion of the computer-generated visualization, such as to directly interact with (e.g., touch, move, swipe, tap, etc.) an object, ray, particle, pattern, or other visual characteristic and/or animation of the computer-generated visualization on the display of the electronic device. In some examples, the input 422B includes information corresponding to input corresponding to an indirect interaction with a portion of the computer-generated visualization, such as hand, arm, finger, head, eye, and/or other movement of the user that is detectable by the electronic device (e.g., such as via a camera of the electronic device), verbal (e.g., speech) input provided by the user of the electronic device that is detectable by the electronic device (e.g., such as via a microphone of the electronic device), and/or movement of the electronic device (e.g., detected via sensors, such as accelerometers and/or gyroscopes). In some examples, the input 422B includes an indication of and/or enables the electronic device to identify the particular user providing the input (e.g., versus another user who has access to and/or is otherwise able to use the electronic device). For example, the input 422B includes biometric information, facial information, retina information, speech information, or other information that enables the electronic device to associate the input with a specific user, and thus, adapt and/or change the computer-generated visualization to correspond to the specific user (e.g., personalize the computer-generated visualization using the recipe 418). In some examples, the input 422B includes information corresponding to input that is directed to a user interface that is being (e.g., concurrently) displayed with the computer-generated visualization on the display of the electronic device. For example, the input 422B includes information corresponding to movement/repositioning and/or resizing of the user interface on the display, selection or other interaction with (e.g., swiping of) a user interface element (e.g., option, button, slider, bar, etc.) that is displayed within the user interface, and/or shifting focus between user interfaces (e.g., windows) on the display while the computer-generated visualization is being displayed on the display of the electronic device. Additional examples regarding the input 422B on a display-limited electronic device are illustrated and described with reference to FIGS. 9A-9H below.

In some examples, the inputs 422A and/or 422B are detectable by the electronic device to update and/or change one or more visual characteristics (e.g., visual attributes that form a visual appearance) of the computer-generated visualization after the recipe 418 for a particular audio track has already been generated (e.g., while the computer-generated visualization is currently being presented by the electronic device). For example, as described in more detail below with reference to FIGS. 9A-9H, the inputs 422A and/or 422B cause the electronic device to update the recipe 418 (e.g., based on the information described above that is included in the inputs 422A and/or 422B), such that the visual appearance of (e.g., colors, size, animation, vibrancy, objects included within, etc.) the computer-generated visualization is visually updated at the electronic device. Accordingly, visually, the computer-generated visualization optionally appears, to the user (e.g., via the display and/or on the display of the electronic device) that the computer-generated visualization is responsive (e.g., in real time) to user input and/or interaction, as discussed in more detail below.

In some examples, the recipe synthesis application 412 and/or the recipe framework 410 are configured to receive application data in addition to and/or in lieu of inputs 422A-422B (e.g., from an operating system of the electronic device 101). For example, the recipe synthesis application 412 and/or the recipe framework 410 receive data from applications running on the electronic device, such as a weather application, a maps application, a calendar application, social media applications, messaging applications, an email application, etc. In some examples, as similarly described above with reference to the inputs 422A-422B, the electronic device is configured to provide, to the recipe synthesis application 412 and/or the recipe framework 410, the application data for use in generating and/or updating the recipe 418 that defines the computer-generated visualization (e.g., defining and/or adjusting one or more visual characteristics of the computer-generated visualization during playback of an audio track). In some examples, the application data is provided to the recipe synthesis application 412 and/or the recipe framework 410 according to one or more user settings and/or preferences (e.g., permissions set and/or defined by the user of the electronic device). Additionally or alternatively, in some examples, the recipe synthesis application 412 and/or the recipe framework 410 are configured to receive data indicating a notification state of the electronic device. For example, a respective electronic device may operate (e.g., as defined by user input and/or pre-set user preferences) in accordance with one or more quiet modes that control and/or define delivery and/or presentation of notifications at the respective electronic device when a notification event is detected (e.g., incoming text message, email, phone call, video call, social media direct message, application notification, etc.). In one example, the electronic device may be operating in a silent mode, such that all notifications are silenced at the electronic device or only user-selected notifications are surfaced at the electronic device. In such an instance, in light of the electronic device operating in the silent mode, the recipe synthesis application 412 and/or the recipe framework 410 adapt the recipe 418 such that the visual appearance of the computer-generated visualization reflects the silent/quiet mode in which the electronic device is operating in (e.g., the animated motion of objects of the computer-generated visualization is reduced and/or a calmer color hue (e.g., cool color tones) is selected for the objects of the computer-generated visualization).

In some examples, as mentioned above, the recipe framework 410 is configured to define one or more display parameters according to which the three-dimensional environment and/or computer-generated visualization (e.g., including virtual objects, colors, etc.) is displayed. In some examples, as shown in FIG. 4A, the recipe framework 410 is in communication with a rendering application 416 that provides (e.g., defines) a spatial arrangement of one or more objects in the three-dimensional environment relative to the position and/or orientation of the electronic device and/or defines a spatial arrangement of one or more objects of the computer-generated visualization on a display of the electronic device (e.g., relative to a position of a user interface on the display of the electronic device).

Additionally or alternatively, in some examples, as alluded to above, the recipe generation process illustrated in FIG. 4A can be provided and/or divided between server-driven and device-driven blocks. For example, as illustrated in FIG. 4B, the data retrieval (e.g., via data source 414 described above) can be performed by a server (e.g., a wireless communications terminal in communication with the electronic device and storing or otherwise having access to the time-synchronized metadata 420), at block 402, and the recipe generation and synthesis operations (e.g., generation and/or modification of the recipe 418) can be performed locally on and/or by the electronic device (e.g., by one or more processors on the electronic device), at block 404. In some examples, when the recipe generation process described above is initiated (e.g., in response to the electronic device detecting user input for displaying a computer-generated visualization for a selected audio track, such as in FIGS. 3A-3B), the electronic device communicates with (e.g., transmits a request to) the server to provide the time-synchronized metadata 420 to the electronic device. It is understood that the elements illustrated in FIG. 4B (e.g., data sources 414, time-synchronized metadata 420, recipe framework 410, recipe synthesis application 412, etc.) correspond to and/or share the same characteristics as the elements illustrated in FIG. 4A described above.

In some examples, as shown in FIG. 4B, the recipe synthesis application 412 can be provided within the recipe framework 410 (e.g., as a single module, application, step, etc.). For example, as illustrated in FIG. 4B, the time-synchronized metadata 420 that is transmitted by the server, at block 402, is received by the recipe framework 410 that is operating on the electronic device, at block 404. In some examples, in response to and/or after receiving the time-synchronized metadata 420 from the server, the recipe framework 410 runs and/or operates the recipe synthesis application 412 to generate the recipe 418 using the time-synchronized metadata 420 as similarly discussed above. The recipe framework 410 uses the recipe 418 to generate and define display parameters for one or more virtual objects (e.g., the computer-generated visualization) that are provided to the rendering applications 416A-416C, as similarly discussed above and as shown in FIG. 4B. As such, in FIG. 4B, the generation of the recipe (e.g., recipe 418 in FIG. 4A) and the subsequent generation of the display parameters are performed and/or driven by the recipe framework 410 on the electronic device, rather than in successive stages and without being performed at the server as discussed previously with reference to FIG. 4A.

In some examples, as shown in FIG. 4B, the recipe synthesis application 412 is configured to generate the recipe without and/or independent of user input (e.g., human intervention), such as the input 422A shown in FIG. 4A. For example, in FIG. 4B, the electronic device limits and/or forgoes responding to (e.g., prevents acceptance of) user inputs that are specifically intended to define or adjust the set of display parameters when requesting display of the computer-generated visualization, such as the user inputs described with reference to FIG. 7 below. As shown in FIG. 4B, the electronic device is still configured to detect and/or respond to live user inputs (e.g., user input 422), such as the inputs 422B discussed above with reference to FIG. 4A.

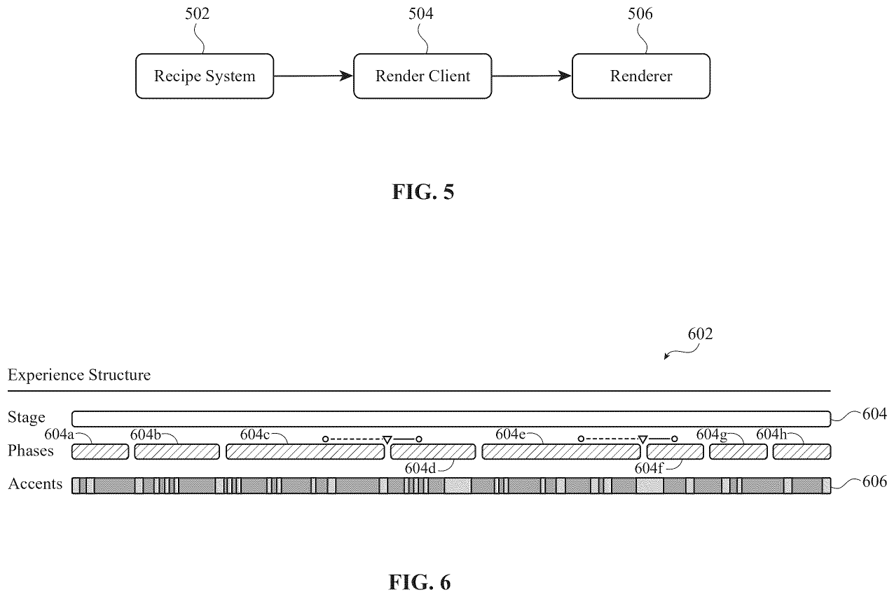

FIG. 5 illustrates an example of a computer-generated visualization rendering process according to some examples of the disclosure. In some examples, the rendering process utilizes a recipe system 502, a render client 504, and a renderer 506. Similar to as described above, the rendering process may convert a set of parameters or time synchronized data into a computer-generated visualization. The recipe system 502 may be configured to perform operations similar to those described with reference to the recipe synthesis application 412 and/or the recipe framework 410 in FIGS. 4A-4B above. The render client 504 may be configured to perform operations similar to those described with reference to rendering applications 416. The renderer 506 may perform operations of the electronic device that present the computer-generated visualization on the display 120 and/or the display generation components 214A/214B of FIGS. 2A-2B.

In some examples, the recipe system 502 includes an accessible data storage that contains time-synchronized metadata, catalog information, audio track data, recipe format (e.g., JSON or other data structure), and/or weights that are used to adjust the values of parameters in the recipe generation process. The output of the recipe system 502 may be a recipe including a set of variables and assigned values such that the render client 504 may convert the recipe to a set of display parameters for an immersive visualization. The render client 504 may output a set of render data that assigns locations, colors, and other visual feature parameters for rendering to a display. In some examples, the recipe system 502 includes a location of a sound (e.g., such as spatial audio) in a three-dimensional environment relative to the position of the user of the electronic device 101 (e.g., relative to the viewpoint of the electronic device 101). For example, for a sound that is mixed in the audio track to one or more spatial positions, the recipe system 502 includes a representation or indication of the one or more positions (e.g., a relative position, coordinates, etc.) in the recipe. In an example, the location may be used as an origin location for particles, or a location where a visual accent (e.g., a flash, a ray, etc.) is presented in the immersive (e.g., three-dimensional and/or virtual) display, as similarly illustrated in FIGS. 3C-3D. In some examples, the recipe system 502 includes a location of a sound on the display of the electronic device relative to a position of a user interface or a user interface element that is also displayed on the display of the electronic device. For example, the recipe system 502 includes a representation or indication of one or more positions associated with the sound on the display of the electronic device that serve as an origin location for particles, visual accents, color array, etc. that are displayed relative to a user interface on the display, as described in more detail below with reference to FIGS. 9A-9H.

FIG. 6 illustrates examples of time-synchronized metadata according to some examples of the disclosure. As described above, time synchronized metadata 602 may be used by the recipe synthesis application or recipe system to generate a recipe for the computer-generated visualization. The time synchronized metadata 602 includes a structured data format that corresponds to each audio track.

In some examples, the time synchronized metadata 602 includes a stage 604, a set of phases 604A-604H, and a set of accents 606. The stage 604 may define a portion up to and including the entire length of the audio track. Each phase may be defined as a portion of the audio track such as a verse, a chorus, a bridge, or other portion of the audio track. Each phase in the set of phases 604A-604H may be a predetermined length that corresponds to a particular audio track. The set of accents 606 may be defined as positions of features in the audio track for which a corresponding acoustic accent (e.g., a beat drop, a cymbal, a change in loudness, etc.) is present in the audio track. The set of time synchronized metadata 602 may include additional features of the audio track as desired such as a sentiment (e.g., lyrics are positive/negative/etc.), a genre, an album theme, inclusion in associated or related playlists, or the like.

FIG. 7 illustrates an example of presenting a real time editing interface for the computer-generated visualization in an immersive mode of the electronic device according to some examples of the disclosure. In some examples, while electronic device 700 is presenting, via display 120, the computer-generated visualization in the three-dimensional environment in the immersive mode described previously above, the electronic device 700 further presents a user interface portion 702. In some examples, the electronic device 700 includes a presentation mode (e.g., presenting only the computer-generated visualization) and/or an editing mode (e.g., presenting the user interface portion 702 and the computer-generated visualization). The electronic device 700 optionally corresponds to electronic device 101 discussed above. The computer-generated visualization includes a portion of the computer-generated visualization and the user interface portion 702. For example, the user interface portion 702 includes an interactive menu element 704 and selectable options 706A-706H (e.g., edits that can be applied to the computer-generated visualization). The user interface portion 702 may be presented concurrently with the computer-generated visualization (e.g., a portion of the computer-generated visualization is occluded by the user interface portion 702), as shown in FIG. 7.

In some examples, such as in the illustration of FIG. 7, the selectable options 706A-706H may include sliders, buttons, text entry fields, or other interactive option that may be manipulated by the user of the electronic device 101. As each of the selectable options 706A-706H is manipulated, the electronic device 700 (using, for example, the render process described above) may modify the computer-generated visualization presented on the display 120. The selectable options 706A-706H may be manipulated by a detected motion of a user's hand, a verbal command, or other user input indicative of a request to modify a value of one or more of the selectable options 706A-706H. Some non-limiting examples of how the selectable options 706A-706H may result in a modified computer-generated visualization include: increasing or decreasing a number of Rays using selectable option 706D, changing a baseline hue using selectable option 706H, changing a luminance of the sky using selectable option 706C, or changing a background of the computer-generated visualization using selectable option 706B. In some examples, with reference to FIGS. 4A-4B above, the recipe framework 410 may adjust the set of display parameters based on changes to the selectable options illustrated in FIG. 7 and may preserve the recipe values as originally generated. In other examples, the recipe framework 410 may update the recipe and store the changes to the selectable options in FIG. 7 to corresponding values in the recipe (e.g., as determined by the user).

It should be understood that, in some examples, multiple electronic devices may be communicatively linked to view the computer-generated visualization concurrently. For example, in a situation in which two electronic devices are communicatively linked, the corresponding portions of the computer-generated visualization (e.g., based on the field of view of each device) may be presented to each of the users of the two electronic devices. It should therefore be understood that the various processes and example interactions described herein with reference to the electronic device 101 optionally apply to situations in which multiple electronic devices are communicatively linked.

It should be understood that the above-described examples for the exclusive display of the immersive environment, such as virtual environments, occupy the field of view of a particular user. These virtual environments may provide the user with six degrees of freedom of movement within a particular virtual environment. It should also be noted that, in some examples, additional and/or alternative factors affect the determination of how the computer-generated visualization is presented to a particular user of an electronic device.

Additionally, it is understood that the examples shown and described herein are non-limiting and that additional and/or alternative elements may be provided within the three-dimensional environment for interacting with the illustrative content. It should be understood that the appearance, shape, form and size of each of the various user interface elements and objects shown and described herein are examples and that alternative appearances, shapes, forms and/or sizes may be provided. Additionally, it should be understood that the various selectable options described herein (e.g., selectable options 706A-706H) may be selected and/or interacted with verbally via user verbal commands (e.g., “select option” verbal command). Additionally or alternatively, in some examples, the various options, user interface elements, control elements, etc. described herein may be selected and/or manipulated via user input received via one or more separate input devices in communication with the electronic device(s). For example, selection input may be received via physical input devices, such as a mouse, trackpad, keyboard, etc. in communication with the electronic device(s).

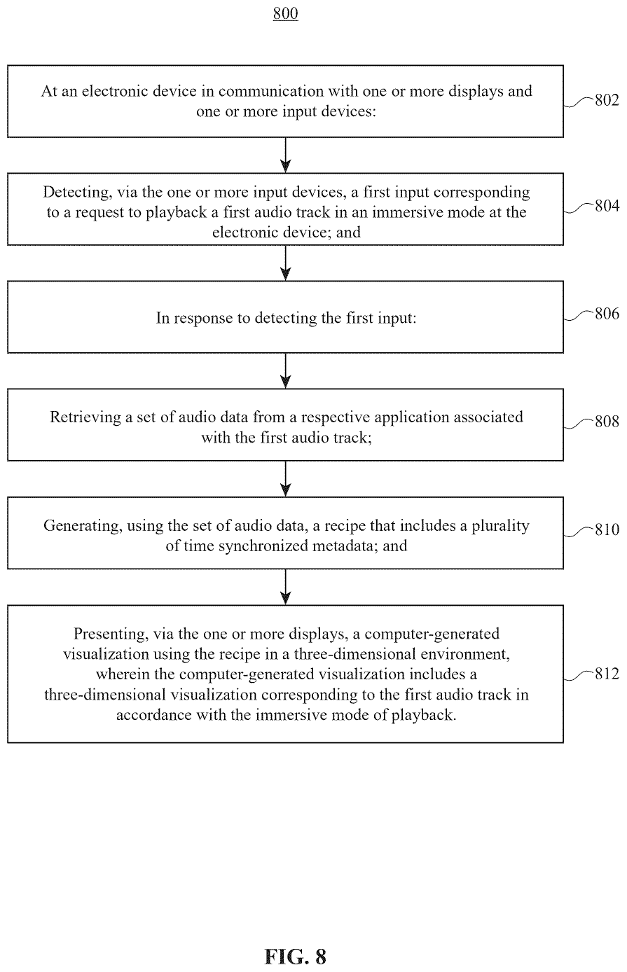

FIG. 8 is a flowchart of an example process 800. In some examples, one or more process blocks of FIG. 8 may be performed by an electronic device such as electronic device 101.

As shown in FIG. 8, process 800 may include blocks which involve, at an electronic device in communication with one or more displays and one or more input devices: at block 802, detecting, via the one or more input devices, a first input corresponding to a request to playback a first audio track in an immersive mode at the electronic device; and at block 802, in response to detecting the first input: block 806, retrieving a set of audio data from a respective application associated with the first audio track; block 808 generating, using the set of audio data, a recipe that includes a plurality of time synchronized metadata; and at block 810, presenting, via the one or more displays, a computer-generated visualization using the recipe in a three-dimensional environment, where the computer-generated visualization includes a three-dimensional visualization corresponding to the first audio track in accordance with the immersive mode of playback (block 810). For example, electronic device may, while in communication with one or more displays (e.g., display 120 of FIGS. 3A-3D) and one or more input devices: detect, via the one or more input devices, a first input corresponding to a request to playback a first audio track in an immersive mode at the electronic device; and in response to detecting the first input: retrieving a set of audio data from a respective application associated with the first audio track; generating, using the set of audio data, a recipe that includes a plurality of time synchronized metadata; and presenting, via the one or more displays, a computer-generated visualization displays (e.g., computer-generated visualization of FIGS. 3A-3D) using the recipe in a three-dimensional environment, where the computer-generated visualization includes a three-dimensional visualization corresponding to the first audio track in accordance with the immersive mode of playback, as described above.

It is understood that process 800 is an example and that more, fewer, or different operations can be performed in the same or in a different order. Additionally, the operations in process 800 described above are, optionally, implemented by running one or more functional modules in an information processing apparatus such as general-purpose processors (e.g., as described with respect to FIGS. 2A-2B) or application specific chips, and/or by other components of FIGS. 2A-2B. In a first example, the set of audio data includes metadata corresponding to one or more of: phases, lyrical data, catalog data, duration data, or acoustic parameters (e.g., time-synchronized metadata 420 of FIGS. 4A-4B).

In some examples, alone or in combination with the first example, the electronic device is further in communication with one or more audio speakers, and where the electronic device, in accordance with communicating with the one or more audio speakers, is configured to perform operations including: determining a type of the one or more audio speakers from a plurality of types of audio speakers, where the type of the one or more audio speakers is associated with a latency parameter; generating a compensation parameter using the latency parameter, where the compensation parameter represents an adjustment to a visual appearance of the computer-generated visualization; and applying the adjustment to the visual appearance of the computer-generated visualization in accordance with the compensation parameter.

In some examples, alone or in combination with the first and second example, the recipe may include a phase parameter, a loudness parameter, and one or more accent parameters.

In some examples, alone or in combination with one or more of the first through third examples, the plurality of time synchronized metadata includes audio attributes such as: danceability, valence, a position of an accent, or a set of weights from a machine learning model.

In some examples, alone or in combination with one or more of the first through fourth examples, generating the recipe includes determining a base hue and a set of initial visual conditions.

In some examples, alone or in combination with one or more of the first through fifth examples, process 800 includes, while presenting the computer-generated visualization in the three-dimensional environment, computing an anticipation progress parameter that represents a position in the first audio track, where the anticipation progress parameter indicates a visual attribute of the computer-generated visualization in the three-dimensional environment (e.g., objects 310A-310D of FIGS. 3C-3D).

In some examples, alone or in combination with one or more of the first through sixth examples, the anticipation progress parameter indicates a relative position of a current position in the first audio track to a position of a next accent, where the accent is an audio event within the first audio track.

In some examples, alone or in combination with one or more of the first through seventh examples, the visual attribute is any one of a color, a shading, a number of particles, a type of particles, an object appearance, or a visual accent of the computer-generated visualization.

In some examples, alone or in combination with one or more of the first through eighth examples, the electronic device includes one or more cameras, and where the electronic device augments the computer-generated visualization with at least a portion of an image captured by the one or more cameras.

In some examples, alone or in combination with one or more of the first through ninth examples, the computer-generated visualization is based on a set of display parameters that causes the computer-generated visualization to be a three-dimensional spatial visualization.

In some examples, alone or in combination with one or more of the first through tenth examples, the set of display parameters includes object parameters including an orientation, a velocity, an acceleration, and an environment parameters a relative position of the computer-generated visualization from a viewpoint of the electronic device in the three-dimensional environment.

In some examples, alone or in combination with one or more of the first through eleventh examples, the computer-generated visualization includes a user interface portion that is configured to receive one or more user inputs, the one or more user inputs controlling the set of display parameters.

In some examples, alone or in combination with one or more of the first through twelfth examples, the user interface portion is presented concurrently with the computer-generated visualization in the three-dimensional environment.

In a fourteenth example, alone or in combination with one or more of the first through thirteenth examples, the electronic device further includes one or more hand tracking sensors configured to detect a position of one or more hands of the user, and where, in response to detecting a motion of a hand of the user via the one or more hand tracking sensors, the electronic device adjusts the computer-generated visualization in the three-dimensional environment.

In some examples, alone or in combination with one or more of the first through fourteenth examples, adjusting the computer-generated visualization changes an orientation, a velocity, an acceleration, or a relative position of an object from a first position in the computer-generated visualization to a second position in the computer-generated visualization.

In some examples, alone or in combination with one or more of the first through fifteenth examples, includes one or more processors; memory; and one or more programs, where the one or more programs are stored in the memory and configured to be executed by the one or more processors, the one or more programs including instructions for performing a method of any of the preceding examples.

In some examples, alone or in combination with one or more of the first through sixteenth examples, the one or more programs having instructions, which when executed by one or more processors of a first electronic device, cause the first electronic device to perform a method of any of the preceding examples.

In some examples, alone or in combination with one or more of the first through seventeenth examples, a magnitude, a velocity, or an intensity of adjusting the computer-generated visualization is based on the motion of the one or more hands of the user.

In some examples, alone or in combination with one or more of the first through eighteenth examples, the user interface portion is presented within an editing mode while the computer-generated visualization is being presented in the three-dimensional environment.

Although FIG. 8 shows example blocks of process 800, in some examples, process 800 may include additional blocks, fewer blocks, different blocks, or differently arranged blocks than those depicted in FIG. 8. Additionally, or alternatively, two or more of the blocks of process 800 may be performed in parallel.

FIGS. 9A-9H illustrate examples of displaying a two-dimensional computer-generated visualization on a display of an electronic device while outputting an audio track according to some examples of the disclosure.

FIG. 9A illustrates examples of electronic devices that are configured to generate and display two-dimensional computer-generated visualizations. For example, FIG. 9A illustrates an example personal computer 910 (e.g., a laptop or desktop computer) that includes a display 912, a keyboard 914 including a plurality of keys, and a trackpad 916. Another example electronic device that is configured to generate and display two-dimensional computer-generated visualizations includes a mobile telephone 920 (e.g., a cellphone or smartphone) that includes a touch screen 922 (e.g., or other touch-sensitive display). FIG. 9A illustrates an example wearable device 930 (e.g., a smartwatch) that includes a touch screen 932 (e.g., or other touch-sensitive display) and a plurality of hardware input elements, such as button 933b and dial 933a (e.g., a rotational input element/button). Wearable device 930 can be coupled to a user (e.g., a wrist of the user) via a strap, band, or any other suitable fastener. Additionally, in some examples, one or more of the above electronic devices include cameras and/or other sensors, such as those described with reference to FIGS. 2A-2B above. It should be understood that the example devices illustrated in FIG. 9A are provided for means of illustration, and other types of devices can generate and display two-dimensional computer-generated visualizations. For example, a digital media player that includes a touch screen or other display can be configured to generate and display two-dimensional computer-generated visualizations. As another example, a tablet computing device that includes a touch screen can be configured to generate and display two-dimensional computer-generated visualizations. Additional examples of such electronic devices are provided above with reference to FIGS. 2A-2B and/or can include smart TVs, vehicles or other automobile computer systems having displays, speaker devices having displays (e.g., such as smart speakers having voice-activated virtual assistants), and the like. Particularly, the electronic devices illustrated in FIG. 9A and described above are configured to operate (e.g., run) or otherwise access (e.g., wirelessly) the recipe framework 410 of FIGS. 4A-4B above for the generation and display of computer-generated visualizations.

FIG. 9B illustrates electronic device 920 (e.g., corresponding to the mobile telephone 920 of FIG. 9A) displaying, via touch screen 922, home user interface 921 of the electronic device 920. For example, as shown in FIG. 9B, the electronic device 920 is displaying a plurality of representations (e.g., icons or images) of a plurality of applications that are able to be launched at the electronic device 920. In some examples, the plurality of representations of the plurality of applications is selectable to cause the electronic device 920 to display a user interface corresponding to the selected application on the touch screen 922. In some examples, as shown in FIG. 9B, the plurality of representations of the plurality of applications includes a representation of a music player application 923 in the home user interface 921. For example, the representation of the music player application 923 is selectable to display a music selection interface and/or a music player interface at the electronic device 920.

In FIG. 9B, while displaying the home user interface 921, the electronic device 920 detects a selection of the representation of the music player application 923. For example, as shown in FIG. 9B, the electronic device 920 detects a tap or selection of contact 903 directed to the representation of the music player application 923 on the touch screen 922. In some examples, the contact 903 corresponds to a finger or other portion of the user, an input device in communication with the electronic device 920, or other suitable input means.

In some examples, as shown in FIG. 9C, in response to detecting the selection of the representation of the music player application 923, the electronic device 920 presents a music selection interface 925 via the touch screen 922. As shown in FIG. 9C, the music selection interface 925 may include multiple selectable options including playback controls 924 and a list of audio tracks (e.g., songs) that are able to be played at the electronic device 920. In FIG. 9C, while displaying the music selection interface 925, the electronic device 920 detects a selection of a first audio track 926 (e.g., “Song B”) of the list of audio tracks. For example, as similarly discussed above, the electronic device 920 detects a tap of contact 903 directed to the first audio track 926 on the touch screen 922. In some examples, in response to detecting the selection of the first audio track 926, the electronic device 920 initiates playback of the first audio track 926 at the electronic device 920. For example, the electronic device 920 outputs audio corresponding to the selected song (e.g., Song B) via one or more speakers of the electronic device 920 and/or via one or more audio output devices in communication with (e.g., wirelessly or in wired connection with) the electronic device 920, such as external speakers, headphones, earbuds, etc.

In some examples, as similarly described herein, when the electronic device 920 outputs an audio track, the electronic device 920 (e.g., automatically) activates an immersive mode of playback at the electronic device 920. In some examples, because the electronic device 920 is a display-limited electronic device (e.g., the electronic device 920 is unable to present three-dimensional (e.g., virtual) content via the two-dimensional touch screen 922), activating the immersive mode of playback includes generating and displaying a two-dimensional computer-generated visualization corresponding to the audio track (e.g., “Song B”). For example, as described above with reference to FIGS. 4A-4B, upon detecting the selection of the first audio track, the electronic device 920 retrieves a set of audio data from music player application associated with the first audio track and generates, using the set of audio data, a recipe that includes a plurality of time synchronized metadata. The recipe optionally includes a set of instructions based on a set of display parameters that causes the computer-generated visualization to be a two-dimensional visualization provided on the touch screen 922 of the electronic device 920, as discussed below.

FIG. 9D illustrates an example of a computer-generated visualization 928 corresponding to an audio track presented by electronic device 920. For example, as indicated in FIG. 9D, the electronic device 920 is playing the audio track selected in FIG. 9C by the user (e.g., first audio track 926), such that audio corresponding to the audio track is being output via one or more audio output devices in communication with the electronic device 920, as similarly discussed above. Additionally, in some examples, as illustrated in FIG. 9D, while the electronic device 920 is playing the audio track, the electronic device 920 displays, via touch screen 922, computer-generated visualization 928 corresponding to the audio track. For example, the computer-generated visualization 928 is displayed using a generated recipe corresponding to the audio track, as discussed previously with reference to FIGS. 4A-4B. In some examples, as shown in FIG. 9D, the electronic device 920 displays the computer-generated visualization 928 concurrently with one or more user interface elements on the touch screen 922. For example, as shown in FIG. 9D, the computer-generated visualization 928 is concurrently displayed with a representation of an album cover 927 corresponding to the audio track and playback controls 924 for the audio track. In some examples, as shown in FIG. 9D, the playback controls 924 also include an audio track identifier (“Song B”) and additional audio track data 308 (e.g., artist name, album title, etc.), in addition to audio/video controls (e.g., scrubber bar, pause/play, rewind and fast forward). In some examples, the computer-generated visualization 928 and the one or more user interface elements are displayed overlaid on and/or within a lock screen user interface of the electronic device 920 (e.g., with and/or behind a current date and time at the electronic device 920, as shown in FIG. 9D). For example, the electronic device 920 activates the immersive mode of playback for the audio track (“Song B”) when the electronic device 920 enters a locked/sleep mode (e.g., while the touch screen 922 remains active) at the electronic device 920, such as in response to detecting a selection or press of a power or sleep button or switch, while the audio of the audio track is being played.

In some examples, one or more visual characteristics of the computer-generated visualization 928 correspond to and/or are based on one or more visual characteristics of the representation of the album cover 927 corresponding to the audio track. For example, as indicated in FIG. 9D, a color, pattern, hue, vibrancy, brightness, saturation, and/or shadow of patterns 929a-929c of the computer-generated visualization 928 match those and/or are similar to those of the representation of the album cover 927. In some examples, referring back to FIGS. 4A-4B, the one or more visual characteristics of the representation of the album cover 927 are included in the time-synchronized metadata 420 stored in data sources 414 and which are used by the recipe synthesis application 412 to generate the recipe 418 corresponding to the audio track (e.g., and which enables the computer-generated visualization 928 to visually match and/or compliment the representation of the album cover 927 on the touch screen 922).

The computer-generated visualization 928 may include visual representations (e.g., patterns 929a-929c and/or objects) of the set of audio data that are generated by converting metadata corresponding to phases, lyrical data, catalog data, duration data, or acoustic parameters associated with the audio track, as discussed above. As the electronic device 920 is displaying the visual representations (e.g., patterns 929a-929c and/or objects) associated with the computer-generated visualization 928 via the touch screen 922, one or more objects (optionally each object) of the visual representations that are displayed may have a unique visual characteristic (e.g., a shape, a position, and/or an orientation) that defines the object on the touch screen 922. For example, a first object may be a particle type of object (e.g., a first type of object) or a curvilinear feature object (e.g., a second type of object), among of possible object types. As shown in FIG. 9D, the touch screen 922 includes multiple types of objects that may be independently generated to correspond to an audio feature of the audio track (e.g., a respective object generated to correspond to a respective audio feature). As discussed herein above, some of the objects (e.g., patterns 929a-929c) correspond to accent portions of the audio track while other objects correspond to a verse, chorus, sentiment, or other aspects of the audio track.

FIG. 9E illustrates another example of a computer-generated visualization 919 corresponding to an audio track presented by an electronic device 910. In FIG. 9E, electronic device 910, optionally corresponding to the personal computer 910 of FIG. 9A, is playing (e.g., outputting) an audio track while displaying, via display 912, one or more user interfaces. For example, as shown in FIG. 9A, the electronic device 910 is displaying a music player user interface 911 associated with a music player application (e.g., via which the electronic device 910 is outputting the audio track, as indicated by player bar 918) and a map user interface 913 associated with a navigation (e.g., maps) application on the display 912. In some examples, as similarly discussed above, the electronic device 910 is outputting the audio track via one or more audio output devices in communication with the electronic device 910, such as speakers of the electronic device 910 or headphones or earbuds in communication with the electronic device 910.

In some examples, as illustrated in FIG. 9E, while outputting the audio track, the electronic device 910 is displaying a computer-generated visualization 919 on the display 912. For example, as shown in FIG. 9E, the electronic device 910 is displaying particles, rays, patterns, and/or other computer-generated objects at and/or along a corner and/or one or more edges of the display 912 concurrently with the music player user interface 911 and the map user interface 913. In some examples, as similarly discussed above with reference to FIGS. 4A-4B, the computer-generated visualization 919 is displayed using a generated recipe corresponding to the audio track. In some examples, one or more visual characteristics of the computer-generated visualization 919 correspond to and/or are based on one or more visual characteristics of the one or more user interfaces displayed on the display 912. Particularly, in FIG. 9E, because multiple user interfaces are displayed on the display 912, the one or more visual characteristics of the computer-generated visualization 919 are based on the user interface that is currently in focus. For example, as shown in FIG. 9E, the map user interface 913 is currently selected and/or in focus (e.g., because cursor 915 of the electronic device 910 is currently positioned over and/or is active in the map user interface 913) on the display 912. Accordingly, the one or more visual characteristics (e.g., visual appearance) of the computer-generated visualization 919 correspond to and/or are based on one or more visual characteristics (e.g., visual appearance) of the map user interface 913 on the display 912. For example, in FIG. 9E, the map user interface 913 includes indications and/or representations of hiking trails, including Hike A, which includes a particular landscape and/or geography, such as greenery 913a. Accordingly, in the example of FIG. 9E, the map user interface 913 includes an overall green hue or color pattern (e.g., due to and/or based on the greenery 913a of Hike A), which causes the computer-generated visualization 919 to have a similarly green hue or color pattern on the display 912. In some examples, as similarly discussed above, the one or more visual characteristics of the map user interface 913 are included in the time-synchronized metadata 420 stored in data sources 414 of FIGS. 4A-4B and which are used by the recipe synthesis application 412 to generate the recipe 418 corresponding to the audio track (e.g., and which enables the computer-generated visualization 919 to visually match and/or compliment the map user interface 913 on the display 912 while the audio track is playing).

It is understood that, in some examples, if the music player user interface 911 alternatively had the focus (e.g., is selected by the cursor 915) in FIG. 9E, the one or more visual characteristics of the computer-generated visualization 919 would alternatively be based on one or more visual characteristics of the music player user interface 911, such as the album artwork associated with the audio track that is currently playing, as similarly discussed above with reference to FIG. 9D. Additionally or alternatively, in some examples, though the visual characteristics (e.g., color, pattern, glow, hue, shape, size, brightness, etc.) of the computer-generated visualization 919 may be based on the visual characteristics of the map user interface 913 in the example of FIG. 9E, an animation or movement of the computer-generated visualization 919 may be based on the playback of the audio track, as similarly discussed above. For example, in FIG. 9E, the computer-generated visualization 919 has a green hue or color pattern based on the greenery 913a in the map user interface 913, but the objects (e.g., particles, rays, patterns, orbs, etc.) forming the computer-generated visualization 919 have an animated motion (e.g., radiation effect, bouncing effect, strobing effect, pulsing effect, etc.) corresponding to the phases, lyrical data, catalog data, duration data, and/or acoustic parameters associated with the audio track, as similarly discussed herein above.

FIG. 9F illustrates another example of a computer-generated visualization 934 corresponding to an audio track presented by an electronic device 930. In FIG. 9F, electronic device 930, optionally corresponding to the wearable electronic device 930 of FIG. 9A, is playing (e.g., outputting) an audio track while displaying, via touch screen 932, a watch user interface. For example, as shown in FIG. 9F, the electronic device 930 is displaying a watch user interface that includes a current time of day at the electronic device 930 on the touch screen 932 while the electronic device 930 is outputting the audio track. In some examples, as similarly discussed above, the electronic device 930 is outputting the audio track via one or more audio output devices in communication with the electronic device 930, such as speakers of the electronic device 930 or headphones or earbuds in communication with the electronic device 930. In some examples, the electronic device 930 is paired with or otherwise in communication with a second electronic device, such as a mobile electronic device (e.g., electronic device 920 in FIG. 9D), such that the electronic device 930 is functioning as a companion device and/or an input device to the second electronic device. For example, in FIG. 9F, the electronic device 930 is paired with and actively communicating with the electronic device 920 of FIG. 9D, and while the electronic device 920 is outputting the audio track (e.g., Song B), the electronic device 930 is able to function as an input device (e.g., via playback controls optionally displayable on the touch screen 932 of the electronic device 930).

In some examples, as illustrated in FIG. 9F, while outputting the audio track (e.g., or while the second electronic device, such as the electronic device 920 is outputting the audio track, as discussed above), the electronic device 930 is displaying a computer-generated visualization 934 on the touch screen 932. For example, as shown in FIG. 9F, the electronic device 930 is displaying objects 935 (e.g., raindrops or teardrops) and/or other computer-generated objects overlaid on the watch user interface (e.g., time “10:09”) on the touch screen 932. In some examples, as similarly discussed above with reference to FIGS. 4A-4B, the computer-generated visualization 934 is displayed using a generated recipe corresponding to the audio track. Additionally, in some examples, the objects 935 of the computer-generated visualization 934 are dynamic and/or animated, such that the object 935 visually move on the touch screen 932 (e.g., move from a top edge to a bottom edge of the touch screen 932 to visually simulate rain or other water droplets falling).

In some examples, as similarly discussed above with reference to FIGS. 4A-4B, one or more visual characteristics of the computer-generated visualization 934 are determined based on a generated recipe (e.g., recipe 418) corresponding to the audio track being output by the electronic device 930 (e.g., and/or by a second electronic device paired with the electronic device 930). For example, with reference to FIGS. 4A-4B, the time-synchronized metadata 420 associated with the audio track and that is stored in data sources 414 are used by the recipe synthesis application 412 to determine a display parameter of the recipe 418, such as an initial shape, form, and/or type of the objects 935 of the computer-generated visualization 934, using one or more of parameters in the time-synchronized metadata 420. For example, the recipe synthesis application 412 may determine a sentiment of the lyrics of the selected audio track (e.g., sad or angry sentiment) and assign a value to an initial form, type, and/or color for the objects 935 (e.g., selecting rain drops or tear drops to match and/or compliment the sad or angry sentiment of the lyrics of the audio track, or a heart to match and/or compliment a happy or love-stricken sentiment as shown in FIG. 9G below). Additionally or alternatively, in some examples, as similarly discussed above, the recipe 418 corresponding to the audio track is generated using data provided by one or more applications running on the electronic device 930 (e.g., and/or the second electronic device paired with the electronic device 930). For example, with reference to FIGS. 4A-4B, recipe synthesis application 412 and/or the recipe framework 410 are provided application data, such as weather data indicating that it is currently raining at the location of the electronic device 930 from a weather application or a web-based application, that enables and/or causes the computer-generated visualization 934 to specifically include the objects 935 (e.g., the rain drops) on the touch screen 932.

FIGS. 9G-9H illustrate examples of updating a visual appearance of a computer-generated visualization 936 in response to detecting an input directed to the computer-generated visualization 936 at an electronic device 930. In FIG. 9G, electronic device 930, optionally corresponding to the wearable electronic device 930 of FIG. 9A, is playing (e.g., outputting) an audio track while displaying, via touch screen 932, a watch user interface. Alternatively, in some examples, the electronic device 930 is paired with or otherwise in communication with a second electronic device, such as a mobile electronic device (e.g., electronic device 920 in FIG. 9D), such that the electronic device 930 is functioning as a companion device and/or an input device to the second electronic device while the second electronic device outputs the audio track. In some examples, as shown in FIG. 9G, the electronic device 930 is displaying a computer-generated visualization 936 that includes object (e.g., a heart) 937 on the touch screen 932 of the electronic device 930. In some examples, as similarly described above, the computer-generated visualization 936 is concurrently displayed with a user interface on the touch screen 932 of the electronic device 930, such as a watch user interface (e.g., current time of day) as similarly shown in FIG. 9F above.

In some examples, as similarly described above, one or more visual characteristics of the computer-generated visualization 936 are determined based on a generated recipe (e.g., recipe 418 in FIGS. 4A-4B) corresponding to the audio track being output by the electronic device 930 (e.g., and/or by a second electronic device paired with the electronic device 930). For example, with reference to FIGS. 4A-4B, the time-synchronized metadata 420 associated with the audio track and that is stored in data sources 414 are used by the recipe synthesis application 412 to determine a display parameter of the recipe 418, such as an initial shape, form, and/or type of the objects 935 of the computer-generated visualization 934, using one or more of parameters in the time-synchronized metadata 420, such as the heart 937 that matches and/or compliments the sentiment of the selected audio track (e.g., a happy or love-stricken sentiment of the lyrics of the audio track). Additionally or alternatively, in some examples, as similarly discussed above, the recipe 418 corresponding to the audio track is generated using data provided by one or more applications running on the electronic device 930 (e.g., and/or the second electronic device paired with the electronic device 930). For example, with reference to FIGS. 4A-4B, the recipe synthesis application 412 and/or the recipe framework 410 are provided application data, such as calendar data indicating that it is the date of the user's wedding anniversary with their partner or it is Valentine's Day, that enables and/or causes the computer-generated visualization 936 to specifically include heart 937 on the touch screen 932.

In some examples, when the user of the electronic device 930 initially selects an audio track (e.g., similar to selection of Song B at electronic device 920 illustrated in FIG. 9C) and initializes presentation of the computer-generated visualization 936 at the electronic device 930, the electronic device 930 automatically associates an initial set of conditions (e.g., a position, shape, type, color, animation, and other parameters) with the objects (e.g., heart 937) of the computer-generated visualization 936. For example, the electronic device 930, using the recipe framework or rendering process described above with reference to FIGS. 4A-4B, assigns a position, a shape, a size, a form, a color, an animated motion, and/or other visual attributes that define the overall visual appearance of the heart 937 of the computer-generated visualization 936 on the touch screen 932. As previously described herein, as the playback of the audio track progresses, the recipe described above may have different values that are used for generating the computer-generated visualization 936, which causes one or more visual aspects (e.g., including the visual appearance) of the computer-generated visualization 936 to change on the touch screen 932. Additionally, as described below, if the electronic device 930 detects an input provided by the user of the electronic device 930, such as a direct input to the computer-generated visualization 936 or an indirect input directed to the electronic device 930, the electronic device 930 updates display of one or more portions of (e.g., the objects included in) the computer-generated visualization 936 on the touch screen 932 in accordance with the input (e.g., the electronic device 930 moves, reshapes, and/or recolors one or more of the objects on the touch screen 932). Particularly, as previously discussed above with reference to FIGS. 4A-4B, the electronic device 930 provides input data corresponding to the detected input to the recipe framework 410 for updating the recipe 418 corresponding to the audio track, thereby updating the visual appearance of the computer-generated visualization 936.

In FIG. 9G, while displaying the computer-generated visualization 936 on the touch screen 932, the electronic device 930 detects a direct input directed to the computer-generated visualization 936. For example, as shown in FIG. 9G, the electronic device 930 detects a tap of contact 903 (e.g., a finger or other input device) directed to the heart 937 on the touch screen 932. In some examples, in response to detecting the direct input directed to the computer-generated visualization 936, the electronic device 930 (e.g., the operating system of the electronic device 930 and/or the operating system of the second electronic device paired with the electronic device 930) provides input data corresponding to the direct input to the recipe framework 410 of FIGS. 4A and/or 4B (e.g., in the form of input 422B as discussed previously herein). For example, the electronic device 930 provides data that includes the portion of the computer-generated visualization 936 to which the input was directed (e.g., the heart 937), the type of input (e.g., tap of contact 903), the location on the touch screen 932 at which the input was detected, a duration of the input (e.g., a measured time between detecting the contact 903 on the touch screen 932 and detecting liftoff of the contact 903 from the touch screen 932), etc. In some examples, in response to receiving the input data (e.g., input 422B in FIGS. 4A-4B), the recipe framework 410 generates an updated recipe 418 that is transmitted to the one or more rendering applications 416 for updating display of the computer-generated visualization 936, as shown in FIG. 9H. Particularly, in some examples, using the updated recipe, the electronic device 930 assigns an updated set of conditions defining the visual appearance of the computer-generated visualization 936, such as an updated position, shape, size, form, color, animated motion, and/or other visual attributes that define the overall visual appearance of the heart 937 of the computer-generated visualization 936 on the touch screen 932.

In some examples, as shown in FIG. 9H, the input directed to the computer-generated visualization 936 causes the electronic device 930 to update display of the computer-generated visualization 936 (e.g., while the audio track continues to be output). For example, as shown in FIG. 9H, the electronic device 930 changes a visual appearance of the heart 937 that is responsive to the detection of the contact 903 being directed to the heart 937 in FIG. 9G, including changing a shape of the heart 937 such that the heart 937 visually appears to ripple and/or break form in response to the direct input on the touch screen 932. Additionally, in some examples, as shown in FIG. 9H, the electronic device 930 updates display of the upper shading and/or patterns of the computer-generated visualization 936 above the heart 937 in response to detecting the direct input (e.g., visually grow and/or change shape based on the change in visual appearance of the heart 937 on the touch screen 932).

In some examples, as mentioned above, the electronic device 930 is configured to detect an indirect input corresponding to interaction with the computer-generated visualization 936 that causes the electronic device 930 to update display of the computer-generated visualization 936 (e.g., by updating the recipe corresponding to the audio track being played back at the electronic device 930). For example, if the electronic device 930 detects an indirect input while displaying the computer-generated visualization 936 on the touch screen 932, such as movement of the electronic device 930, the electronic device 930 transmits input data corresponding to the indirect input to the recipe synthesis process described above for updating the visual appearance of the computer-generated visualization 936 on the touch screen 932, as similarly shown in FIG. 9H. In some examples, as mentioned above, the electronic device 930 is a wearable electronic device, such as a smart watch configured to be worn on a wrist of the user. As such, the movement of the electronic device 930 that constitutes an indirect input includes movement (e.g., and/or other gestures) of the wrist of the user, such as a flick or rotation of the wrist of the user and/or a change in elevation of the wrist of the user (e.g., relative to gravity).

It is understood that, in some examples, additional or alternative examples of electronic devices that are displaying and/or presenting computer-generated visualizations associated with playback of audio tracks (e.g., using the recipe synthesis process of FIGS. 4A-4B) are configured to detect and respond to user inputs that update the visual appearance of the computer-generated visualizations. For example, referring back to FIG. 9D above, while the electronic device 920 is displaying the computer-generated visualization 928 while outputting the selected audio track (e.g., Song B), if the electronic device 920 detects a direct input or an indirect input corresponding to interaction with the computer-generated visualization 928, the electronic device 930 provides input data corresponding to the detected user input to the recipe synthesis process shown in FIGS. 4A-4B for updating the recipe corresponding to the selected audio track, thereby causing the electronic device 920 to update a visual appearance of the computer-generated visualization 928 on the touch screen 922. In some examples, detecting a direct input that causes the electronic device 920 to update display of the computer-generated visualization 928 includes detecting a contact (e.g., contact 903) directed to a portion of the computer-generated visualization 928 on the touch screen 922, such as a tap or movement of a finger directed to the patterns 929a-929c. In some examples, detecting an indirect input that causes the electronic device 920 to update display of the computer-generated visualization 928 includes detecting movement of the electronic device 920 (e.g., via one or more sensors of the electronic device 920, such as an accelerometer or gyroscope), such as detecting a shaking or jerking motion of the electronic device 920, a rotation of the electronic device 920, a change in elevation of the electronic device 920 (e.g., relative to gravity), etc. In some examples, detecting the indirect input includes detecting verbal input (e.g., speech or audio input) provided by the user and/or in a physical environment surrounding the electronic device 920. For example, the electronic device 920 is configured to detect, via one or more microphones of the electronic device 920, the user singing or humming along to the lyrics and/or beats of the audio track, a plurality of users singing or humming along to the lyrics and/or beats of the audio track, etc. In some examples, detecting the indirect input includes detecting movement of the user of the electronic device 920 (e.g., relative to the electronic device 920). For example, the electronic device 920 is configured to detect, via one or more cameras of the electronic device 920, and optionally while the electronic device 920 remains stationary, movement of one or more portions of the user, such as movement of one of more arms and/or hands of the user, movement of the head of the user, movement of the torso of the user, etc. (optionally indicative of the user dancing along to the audio track). In some examples, updating display of the computer-generated visualization 928 on the touch screen 922 includes changing one or more visual characteristics of the patterns 929a-929c of the computer-generated visualization 928, as similarly discussed above.

As another example, referring back to FIG. 9E above, while the electronic device 910 is displaying the computer-generated visualization 919 while outputting the selected audio track (e.g., as indicated by the playback controls 918), if the electronic device 910 detects a direct input or an indirect input corresponding to interaction with the computer-generated visualization 919, the electronic device 910 provides input data corresponding to the detected user input to the recipe synthesis process shown in FIGS. 4A-4B for updating the recipe corresponding to the selected audio track, thereby causing the electronic device 910 to update a visual appearance of the computer-generated visualization 919 on the display 912. In some examples, detecting a direct input that causes the electronic device 910 to update display of the computer-generated visualization 919 includes detecting a selection or other cursor-based interaction directed to a portion of the computer-generated visualization 919 on the display 912, such as a tap or movement of a finger on the trackpad of the electronic device 910 which controls the cursor 915. In some examples, detecting an indirect input that causes the electronic device 910 to update display of the computer-generated visualization 928 includes detecting verbal input (e.g., speech or audio input) provided by the user and/or in a physical environment surrounding the electronic device 910. For example, the electronic device 910 is configured to detect, via one or more microphones of the electronic device 910, the user singing or humming along to the lyrics and/or beats of the audio track, a plurality of users singing or humming along to the lyrics and/or beats of the audio track, etc. In some examples, detecting the indirect input includes detecting movement of the user of the electronic device 910 (e.g., relative to the electronic device 910). For example, the electronic device 910 is configured to detect, via one or more cameras of the electronic device 910, and optionally while the electronic device 910 remains stationary, movement of one or more portions of the user, such as movement of one of more arms and/or hands of the user, movement of the head of the user, movement of the torso of the user, etc. (optionally indicative of the user dancing along to the audio track). In some examples, updating display of the computer-generated visualization 919 on the display 912 includes changing one or more visual characteristics of the particles and/or rays of the computer-generated visualization 919, as similarly discussed above.

In some examples, a respective electronic device (e.g., such as electronic device 101, electronic device 910, electronic device 920, and/or electronic device 930) selectively operates and/or adjusts a frequency of operation of input devices and/or specific types of input devices in communication with the respective electronic device based on metadata associated with a selected audio track. For example, as previously described with reference to FIGS. 4A-4B, the recipe synthesis application 412 may receive (or otherwise access) the data sources 414 to retrieve a set of time-synchronized metadata 420 associated with the audio track. In some examples, the set of time-synchronized metadata 420 includes lyric data, quality or state of being danceable, musical valence, a position of an accent, beats per minute, phase, or other qualities of the audio track, as similarly discussed herein above. In some examples, as previously discussed above, the recipe synthesis application 412 of FIGS. 4A-4B may determine, using the time-synchronized metadata 420, a recipe 418 that includes a plurality of parameters, such as a display parameter, which is provided to the recipe framework 410. In some examples, the recipe 418 or other data generated by the recipe synthesis application 412 may include an indication of certain key attributes of the audio track as pertaining to certain types or classes of input devices of the respective electronic device. For example, if the selected audio track does not have any lyrics associated with it, the recipe 418 or other data output by the recipe synthesis application 412 includes an indication that the audio track will not include singing. As another example, if the selected audio track has a high beats per minute value or other indication of being danceable, the recipe 418 or other data output by the recipe synthesis application 412 includes an indication that the audio track will be danceable. In some examples, the indications of certain attributes of the audio track that will be played at the respective electronic device enable the respective electronic device to selectively operate the input devices in communication with the respective electronic device, as certain inputs by the user are anticipated based on the indications of the attributes. For example, as mentioned above, if a selected audio track has been identified (e.g., by the recipe synthesis application 412) as having lyrics, the respective electronic device may, once the audio track is being played, operate the microphones (optionally over regular intervals) of the respective electronic device in anticipation of detecting speech input from the user (e.g., the user is singing along to the lyrics), which then enables the respective electronic device to update the visual appearance of the computer-generated visualization in the manners described previously herein. As another example, if a selected audio track has been identified (e.g., by the recipe synthesis application 412) as being danceable, the respective electronic device may, once the audio track is being played, operate the cameras (optionally over regular intervals) of the respective electronic device in anticipation of detecting motion-based input from the user (e.g., the user is dancing along to the song), which then enables the respective electronic device to update the visual appearance of the computer-generated visualization in the manners described previously herein. Selective operation of the input devices of the respective electronic device based on identified attributes of a selected audio track helps conserve computing resources and therefore battery life, as one benefit.

In some examples, the visual characteristics and/or attributes of the displayed computer-generated visualization are based on physical characteristics and/or properties of a display of a respective electronic device on which the computer-generated visualization is displayed. For example, the wearable electronic device 930 (e.g., smart watch) of FIGS. 9F-9H has a smaller display (e.g., smaller in size) than the touch screen 922 of the telephone device 920 of FIG. 9D. Accordingly, in some examples, the relative sizes of the objects (e.g., particles, rays, patterns, orbs, etc.) included in the computer-generated visualizations displayed on the touch screen 922 of the electronic device 920 may be different (e.g., larger) compared to the computer-generated visualizations displayed on the touch screen 932 of the electronic device 930. In another example, the corners and/or edges of the display 912 of the personal computer 910 in FIG. 9E are sharper (e.g., more pointed or thinner) than the corners and/or edges of the touch screen 932 of the wearable device 930 of FIGS. 9F-9H (e.g., the touch screen 932 has more rounded corners and/or edges). Accordingly, in some examples, the relative shapes of the objects (e.g., particles, rays, patterns, orbs, etc.) included in the computer-generated visualizations displayed at the corners of the display 912 of the electronic device 910 may be different (e.g., more angular/pointed or sharp at the corners) compared to the computer-generated visualizations displayed on the touch screen 932 of the electronic device 930 (e.g., which would be more rounded or curved, as similarly shown in FIG. 9G). Additionally or alternatively, in some examples, a visual animated motion of the computer-generated visualization can be based on the physical properties of the display of the respective electronic device on which the computer-generated visualization is displayed. For example, the objects (e.g., particles, rays, patterns, orbs, etc.) included in the computer-generated visualizations can visually appear to bounce off, deflect from, or otherwise physically interact with the edges and/or corners of the display of the respective electronic device. Additionally or alternatively, in some examples, the electronic device is configured to communicate with a wireless server, and in response to detecting the first input: retrieving the set of audio data from the respective application associated with the first audio track includes receiving, from the wireless server, the set of audio data; and generating, using the set of audio data, the plurality of time synchronized metadata is performed locally at the electronic device.

It is understood that the computer-generated visualizations illustrated in and described with reference to FIGS. 9A-9H have one or more characteristics of the computer-generated visualizations illustrated in and described with reference to FIGS. 3A-3D above. Thus, as outlined above, by incorporating the time synchronized metadata into a recipe, the systems and methods described herein provide a proactive, rather than a reactive, approach to enhanced playback of audio tracks and which is responsive to user input, thereby improving the visual feedback provided to the user and producing a visualization that improves audio and visual synchronization, which also improves user-device interaction.

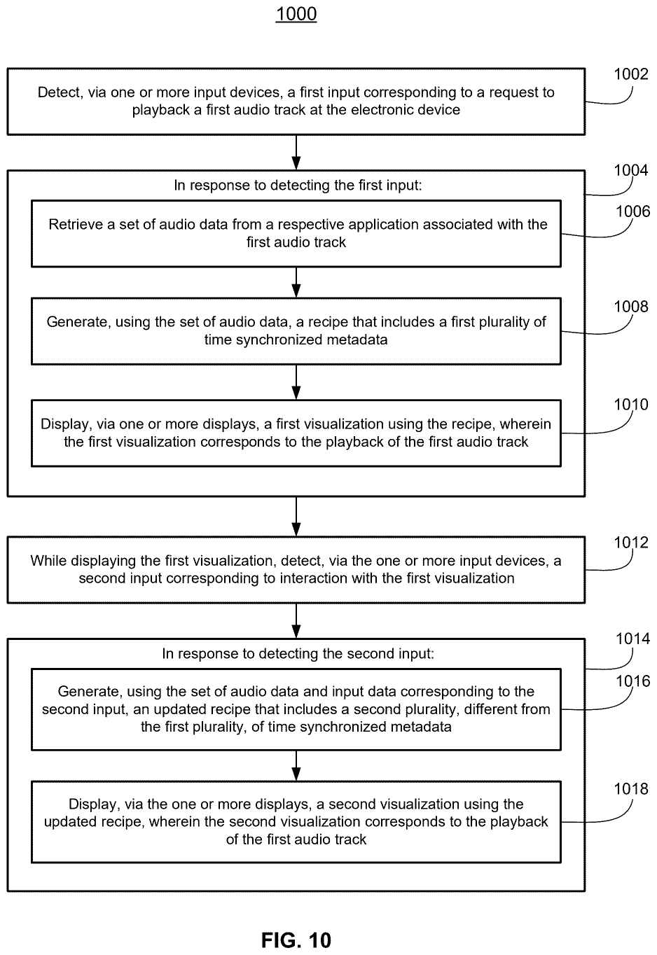

FIG. 10 illustrates a flow diagram illustrating an example process 1000 for displaying a two-dimensional computer-generated visualization on a display of an electronic device while outputting an audio track according to some examples of the disclosure. In some examples, the electronic device is optionally a head-mounted display similar or corresponding to electronic device 201 of FIG. 2A or a mobile electronic device similar or corresponding to electronic device 260 of FIG. 2B. In some examples, the electronic device is in communication with one or more displays and one or more input devices. As shown in FIG. 10, in some examples, at 1002, at an electronic device detects, via the one or more input devices, a first input corresponding to a request to playback a first audio track at the electronic device. For example, as shown in FIG. 9C, electronic device 920 detects a tap of contact 903 on touch screen 922 corresponding to a request to playback “Song B” within a music player application.

In some examples, at 1004, in response to detecting the first input, at 1006, the electronic device retrieves a set of audio data from a respective application associated with the first audio track. For example, in FIGS. 4A-4B, the electronic device retrieves data from data sources 414 corresponding to the selected audio track from the music player application. In some examples, at 1008, the electronic device generates, using the set of audio data, a recipe that includes a first plurality of time synchronized metadata. For example, in FIGS. 4A-4B, the electronic device generates recipe 418 associated with the audio track. In some examples, at 1010, the electronic device displays, via the one or more displays, a first visualization using the recipe, wherein the first visualization corresponds to the playback of the first audio track. For example, as shown in FIG. 9F, electronic device 930 displays computer-generated visualization 934 on touch screen 932 in accordance with the generated recipe.

In some examples, at 1012, while displaying the first visualization, the electronic device detects, via the one or more input devices, a second input corresponding to interaction with the first visualization. For example, while displaying computer-generated visualization 936, the electronic device 930 detects a tap of contact 903 directed to heart 937 on the touch screen 932. In some examples, at 1014, in response to detecting the second input, at 1016, the electronic device generates, using the set of audio data and input data corresponding to the second input, an updated recipe that includes a second plurality, different from the first plurality, of time synchronized metadata. For example, in FIGS. 4A-4B, recipe framework 410 receives input data corresponding to the detected input and updates the recipe corresponding to the audio track. In some examples, at 1018, the electronic device displays, via the one or more displays, a second visualization using the updated recipe, wherein the second visualization corresponds to the playback of the first audio track. For example, as shown in FIG. 9H, the electronic device 930 updates display of the computer-generated visualization 936 to include an amorphous heart 937 in accordance with the input detected on the touch screen 932.

It is understood that process 1000 is an example and that more, fewer, or different operations can be performed in the same or in a different order. Additionally, the operations in process 1000 described above are, optionally, implemented by running one or more functional modules in an information processing apparatus such as general-purpose processors (e.g., as described with respect to FIGS. 2A-2B) or application specific chips, and/or by other components of FIGS. 2A-2B. In a first example, the set of audio data includes metadata corresponding to one or more of: phases, lyrical data, catalog data, duration data, or acoustic parameters (e.g., time-synchronized metadata 420 of FIGS. 4A-4B).

Therefore, according to the above, some examples of the disclosure are directed to a method comprising, at an electronic device in communication with one or more displays and one or more input devices: detecting, via the one or more input devices, a first input corresponding to a request to playback a first audio track at the electronic device; in response to detecting the first input, retrieving a set of audio data from a respective application associated with the first audio track, generating, using the set of audio data, a recipe that includes a first plurality of time synchronized metadata, and displaying, via the one or more displays, a first visualization using the recipe, wherein the first visualization corresponds to the playback of the first audio track; while displaying the first visualization, detecting, via the one or more input devices, a second input corresponding to interaction with the first visualization; and in response to detecting the second input, generating, using the set of audio data and input data corresponding to the second input, an updated recipe that includes a second plurality, different from the first plurality, of time synchronized metadata, and displaying, via the one or more displays, a second visualization using the updated recipe, wherein the second visualization corresponds to the playback of the first audio track.

Additionally or alternatively, in some examples, the set of audio data includes metadata corresponding to one or more of: phases, lyrical data, catalog data, duration data, or acoustic parameters. Additionally or alternatively, in some examples, the electronic device is further in communication with one or more audio speakers, the method further comprising: in response to detecting the first input, outputting, via the one or more audio speakers, first audio corresponding to the first audio track while displaying the first visualization via the one or more displays; and in response to detecting the second input, maintaining output of the first audio corresponding to the first audio track while displaying the second visualization via the one or more displays. Additionally or alternatively, in some examples, the recipe includes a phase parameter, a loudness parameter, and one or more accent parameters. Additionally or alternatively, in some examples, the plurality of time synchronized metadata includes audio attributes, including danceability, valence, a position of an accent, or a set of weights from a machine learning model. Additionally or alternatively, in some examples, generating the recipe includes determining a base hue and a set of initial visual conditions. Additionally or alternatively, in some examples, generating the updated recipe includes determining an updated base hue and a set of updated visual conditions. Additionally or alternatively, in some examples, the one or more input devices include a touch-sensitive surface, and detecting the second input includes detecting a user input directed to the touch-sensitive surface. Additionally or alternatively, in some examples, the one or more input devices include one or more cameras, and detecting the second input includes detecting, via the one or more cameras, movement of a user of the electronic device. Additionally or alternatively, in some examples, the one or more input devices include one or more microphones, and detecting the second input includes detecting, via the one or more microphones, verbal input provided by a respective user of the electronic device. Additionally or alternatively, in some examples, in accordance with a determination that the respective user is a first user of the electronic device, the second visualization has one or more first visual attributes, and in accordance with a determination that the respective user is a second user, different from the first user, of the electronic device, the second visualization has one or more second visual attributes, different from the one or more first visual attributes.

Additionally or alternatively, in some examples, the one or more input devices include one or more sensors, and detecting the second input includes detecting, via the one or more sensors, movement of the electronic device. Additionally or alternatively, in some examples, the one or more displays include a first display, and in accordance with a determination that the first display has one or more first physical properties, the first visualization has one or more first visual attributes. Additionally or alternatively, in some examples, in accordance with a determination that the first display has one or more second physical properties, different from the one or more first physical properties, the first visualization has one or more second visual attributes, different from the one or more first visual attributes. Additionally or alternatively, in some examples, generating the recipe further includes determining a set of display parameters that includes object parameters, and the object parameters include an orientation, a velocity, an acceleration, and a relative position of the first visualization on the one or more displays. Additionally or alternatively, in some examples, generating the updated recipe further includes determining updated object parameters, including adjusting one or more of the orientation, the velocity, the acceleration, and the relative position of the second visualization on the one or more displays.

Some examples of the disclosure are directed to a first electronic device comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of a first electronic device, cause the first electronic device to perform any of the above methods.

Some examples of the disclosure are directed to a first electronic device, comprising one or more processors, memory, and means for performing any of the above methods.

Some examples of the disclosure are directed to an information processing apparatus for use in a first electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

1. A method comprising:
at an electronic device in communication with one or more displays and one or more input devices:
detecting, via the one or more input devices, a first input corresponding to a request to playback a first audio track in an immersive mode at the electronic device; and
in response to detecting the first input:
retrieving a set of audio data from a respective application associated with the first audio track;
generating, using the set of audio data, a plurality of time synchronized metadata; and
presenting, via the one or more displays, a computer-generated visualization using the plurality of time synchronized metadata in a three-dimensional environment, wherein the computer-generated visualization includes a three-dimensional visualization corresponding to the first audio track in accordance with the immersive mode of playback.

2. The method of claim 1, wherein the set of audio data includes metadata corresponding to one or more of: phases, lyrical data, catalog data, duration data, or acoustic parameters.

3. The method of claim 1, wherein the electronic device is further in communication with one or more audio speakers, and wherein the electronic device, in accordance with communicating with the one or more audio speakers, is configured to perform operations including:
determining a type of the one or more audio speakers from a plurality of types of audio speakers, wherein the type of the one or more audio speakers is associated with a latency parameter;
generating a compensation parameter using the latency parameter, wherein the compensation parameter represents an adjustment to a visual appearance of the computer-generated visualization; and
applying the adjustment to the visual appearance of the computer-generated visualization in accordance with the compensation parameter.

4. The method of claim 1, wherein the plurality of time synchronized metadata comprises a phase parameter, a loudness parameter, and one or more accent parameters.

5. (canceled)

6. The method of claim 1, wherein generating the plurality of time synchronized metadata includes determining a base hue and a set of initial visual conditions.

7. The method of claim 1, further comprising, while presenting the computer-generated visualization in the three-dimensional environment, computing an anticipation progress parameter that represents a position in the first audio track, wherein the anticipation progress parameter indicates a visual attribute of the computer-generated visualization in the three-dimensional environment.

8-11. (canceled)

12. The method of claim 1, wherein the set of display parameters includes object parameters including an orientation, a velocity, an acceleration, and an environment parameters a relative position of the computer-generated visualization from a viewpoint of the electronic device in the three-dimensional environment.

13-15. (canceled)

16. The method of claim 1, wherein the electronic device further comprises one or more hand tracking sensors configured to detect a position of one or more hands of a user of the electronic device, and wherein, in response to detecting a motion of a hand of the user via the one or more hand tracking sensors, the electronic device adjusts the computer-generated visualization in the three-dimensional environment.

17-19. (canceled)

20. An electronic device, comprising:
one or more processors;
memory; and
one or more programs, wherein the one or more programs are stored in the memory and configured to be executed by the one or more processors, the one or more programs including instructions for:
detecting, via one or more input devices, a first input corresponding to a request to playback a first audio track in an immersive mode at the electronic device; and
in response to detecting the first input:
retrieving a set of audio data from a respective application associated with the first audio track;
generating, using the set of audio data, a plurality of time synchronized metadata; and
presenting, via one or more displays, a computer-generated visualization using the plurality of time synchronized metadata in a three-dimensional environment, wherein the computer-generated visualization includes a three-dimensional visualization corresponding to the first audio track in accordance with the immersive mode of playback.

21. A non-transitory computer readable storage medium storing one or more programs, the one or more programs comprising instructions, which when executed by one or more processors of an electronic device, cause the electronic device to perform:
detecting, via one or more input devices, a first input corresponding to a request to playback a first audio track in an immersive mode at the electronic device; and
in response to detecting the first input:
retrieving a set of audio data from a respective application associated with the first audio track;
generating, using the set of audio data, a plurality of time synchronized metadata; and
presenting, via one or more displays, a computer-generated visualization using the plurality of time synchronized metadata in a three-dimensional environment, wherein the computer-generated visualization includes a three-dimensional visualization corresponding to the first audio track in accordance with the immersive mode of playback.

22-43. (canceled)

44. The electronic device of claim 20, wherein the set of audio data includes metadata corresponding to one or more of: phases, lyrical data, catalog data, duration data, or acoustic parameters.

45. The electronic device of claim 20, wherein the electronic device is further in communication with one or more audio speakers, and wherein the electronic device, in accordance with communicating with the one or more audio speakers, is configured to perform operations including:
determining a type of the one or more audio speakers from a plurality of types of audio speakers, wherein the type of the one or more audio speakers is associated with a latency parameter;
generating a compensation parameter using the latency parameter, wherein the compensation parameter represents an adjustment to a visual appearance of the computer-generated visualization; and
applying the adjustment to the visual appearance of the computer-generated visualization in accordance with the compensation parameter.

46. The electronic device of claim 20, wherein the plurality of time synchronized metadata comprises a phase parameter, a loudness parameter, and one or more accent parameters.

47. The electronic device of claim 20, wherein generating the plurality of time synchronized metadata includes determining a base hue and a set of initial visual conditions.

48. The electronic device of claim 20, wherein the one or more programs further include instructions for, while presenting the computer-generated visualization in the three-dimensional environment, computing an anticipation progress parameter that represents a position in the first audio track, wherein the anticipation progress parameter indicates a visual attribute of the computer-generated visualization in the three-dimensional environment.

49. The electronic device of claim 20, wherein the set of display parameters includes object parameters including an orientation, a velocity, an acceleration, and an environment parameters a relative position of the computer-generated visualization from a viewpoint of the electronic device in the three-dimensional environment.

50. The electronic device of claim 20, further comprising one or more hand tracking sensors configured to detect a position of one or more hands of a user of the electronic device, and wherein, in response to detecting a motion of a hand of the user via the one or more hand tracking sensors, the electronic device adjusts the computer-generated visualization in the three-dimensional environment.

51. The non-transitory computer readable storage medium of claim 21, wherein the set of audio data includes metadata corresponding to one or more of: phases, lyrical data, catalog data, duration data, or acoustic parameters.

52. The non-transitory computer readable storage medium of claim 21, wherein the electronic device is further in communication with one or more audio speakers, and wherein the electronic device, in accordance with communicating with the one or more audio speakers, is configured to perform operations including:
determining a type of the one or more audio speakers from a plurality of types of audio speakers, wherein the type of the one or more audio speakers is associated with a latency parameter;
generating a compensation parameter using the latency parameter, wherein the compensation parameter represents an adjustment to a visual appearance of the computer-generated visualization; and
applying the adjustment to the visual appearance of the computer-generated visualization in accordance with the compensation parameter.

53. The non-transitory computer readable storage medium of claim 21, wherein the plurality of time synchronized metadata comprises a phase parameter, a loudness parameter, and one or more accent parameters.

54. The non-transitory computer readable storage medium of claim 21, wherein generating the plurality of time synchronized metadata includes determining a base hue and a set of initial visual conditions.

55. The non-transitory computer readable storage medium of claim 21, wherein the instructions further cause the electronic device to perform, while presenting the computer-generated visualization in the three-dimensional environment, computing an anticipation progress parameter that represents a position in the first audio track, wherein the anticipation progress parameter indicates a visual attribute of the computer-generated visualization in the three-dimensional environment.

56. The non-transitory computer readable storage medium of claim 21, wherein the set of display parameters includes object parameters including an orientation, a velocity, an acceleration, and an environment parameters a relative position of the computer-generated visualization from a viewpoint of the electronic device in the three-dimensional environment.

57. The non-transitory computer readable storage medium of claim 21, wherein the electronic device further comprises one or more hand tracking sensors configured to detect a position of one or more hands of a user of the electronic device, and wherein, in response to detecting a motion of a hand of the user via the one or more hand tracking sensors, the electronic device adjusts the computer-generated visualization in the three-dimensional environment.
